(19) United States
(12) Patent Application Publication
(10) Pub. No.: US 2022/0228315 A1
(43) Pub. Date: Jul. 21, 2022

(54) METHOD FOR PRINTING ON NON-WOVEN TEXTILE SUBSTRATES USING RADIATION-CURING INKS

(71) Applicant: BASF Coatings GmbH, Münster (DE)

(72) Inventors: Christian Arens, Münster (DE); Fabian Wessel, Münster (DE); Susanne Piontex, Münster (DE); Sixtine Le Borgne, Münster (DE); Ruben Van Knippenberg, AS Maarssen (DE); Andrea Heselmaier, Münster (DE)

(21) Appl. No.: 17/605,149

(22) PCT Filed: Mar. 25, 2020
(86) PCT No.: PCT/EP2020/058380

§ 371 Date: Oct. 20, 2021

(30) Foreign Application Priority Data
Apr. 23, 2019 (EP) 19170531.8

(51) Int. Cl. D06P 5/30; B41M 7/00; B41M 5/00; D06P 1/52

(52) U.S. Cl. CPC D06P 5/30; B41M 7/0045; B41M 7/0081; D06P 1/5285; B41M 5/0047; D06P 1/5257; B41M 5/0023

(57) ABSTRACT

Described herein are aqueous coating compositions including at least one dispersion of core/shell particles containing a polyurethane resin as core portion and a crosslinked acrylic resin as shell portion and at least one aqueous polyurethane-polyurea dispersion containing crosslinked polyurethane-polyurea particles. Also described herein is a method for forming a multilayer coating on a substrate using the aqueous coating compositions as basecoat compositions. Also described herein is a multicoat paint system produced by the method.

The present invention relates to a method for coating a non-woven textile substrate (S) at least partially with an ink layer (IL), said method comprising at least three steps, namely providing the non-woven textile substrate (S), depositing a specific pigmented ink composition (AC) over at least a portion of at least one surface of the non-woven textile substrate (S) and drying and/or at least partially curing the deposited ink composition (AC) on the non-woven textile substrate (S). Moreover, the present invention relates to a non-woven textile substrate (S) at least partially coated with an ink layer (IL) obtained by the inventive method.

### PRIOR ART

The growing market of printing complex designs and images on almost every type of surface, and especially on woven and non-woven textile surfaces, plasticized and laminated fabrics (soft signage) and the likes, creates demands for new and more versatile printing technologies and ink compositions. One such demand is for ink compositions and printing technologies which will be suitable for printing long lasting, durable, abrasion resistant, water-, detergent- and chemical-fast color images on a variety of materials, which will not wear out rapidly upon use, handling, washing and exposure to the environment. The garment industry is possibly the most demanding in terms of printing high quality and durable prints of textile, adding some requirements from the product, such as pleasant hand-feel of the printed area, flexible (bendable without cracking), stretchable and aerated print area, as well as following the guidelines of internationally accepted standards such as the Oeko-Tex Standard 100 (an international testing and certification system for textiles, limiting the use of certain chemicals, which was developed in 1992) and GOTS (Global Organic Textile Standard).

One of the most promising technologies for printing high quality color images, particularly in small batches of varying contents (short runs of variable data), on a wide variety of types and shapes of substrates, such as woven and non-woven substrates, is inkjet printing. Inkjet printing is a nonimpact method in which small droplets of ink are directed from a nozzle onto a printable porous or non-porous substrate.

Inkjet printing processes fall into two main types: continuous processes and drop-on-demand (DOD) processes. Continuous processes use electrically conductive inks to produce a stream of electrically-charged ink drops that are deflected by an electric field to an appropriate location on the substrate. In contrast, individual drops of ink are expelled from the nozzle of a printhead either by vibration of a piezoelectric actuator (in piezoelectric inkjet printing) or by heating the ink to form a bubble (in thermal inkjet printing, also known as bubblejet printing) in DOD processes. Jet velocity, separation length of the droplets, drop size and stream stability are all greatly affected by the surface tension and the viscosity of the ink. In contrast to screen printing, inks used in inkjet printing are required to have a relatively low viscosity and small particle size to have satisfactory jetting characteristics.

The presently available ink compositions, including compositions that are suitable for inkjet printing, include aqueous-based ink compositions and non-aqueous solvent-based ink compositions. The more commonly used inkjet compositions are solvent-based ink compositions, which typically include solvent and a colorant, usually a dye or pigment dispersion, and may further contain a number of additives for imparting certain attributes to the ink as it is being applied (jetted), e.g., improved stability and flow, anti-corrosiveness, and feather and bleeding resistance, as well as attributes to affect its final cured properties such as the capability to form chemical bonds with the substrate, improved adhesion to the substrate, flexibility, stretchability, softness and the like.

To ensure high quality images by inkjet printing, the ink composition should be characterized by free passage through the nozzles, minimal bleeding, paddling and/or smearing, uniform printing on the surface of the subject, wash-fastness, simple system cleaning and other chemical and physical characteristics. To meet these requirements, the ink composition should be characterized, for example, by suitable viscosity, solubility, volatility, surface tension, compatibility with other components of the printing system and further be applied using suitable apparatus, techniques and processes.

In order to sustain wear and tear due to frequent use and/or wash cycles of printed fabrics (e.g., printed garments), the printed image on the final product, as well as the final product itself, should exhibit the properties of an elastic yet aerated film, and therefore the ink composition should also contain components which can impart such compressibility (softness), plasticity, elasticity, flexibility and stretchability.

One of the challenges in printing on fabric, especially on non-woven fabric, is its low absorbability, which results in the need to optimize the printhead and its control as well as the ink so that a high resolution of the printed image as well as a durable fixation of the ink to the substrate is realized.

### Object

Therefore, an object of the present invention is to provide a method for printing on non-woven textile substrates which results in high resolution images as well as good performance properties of the printed substrate, for example in terms of color strength, dye-binding stability, wetfastness, non-toxicity and flexibility. Preferably, the method should not have a negative influence on the haptic and the properties of the substrate or interfere with further processing of the substrate. Moreover, the printing inks to be used in the method should not exhibit any disadvantages in terms of their viscosity, stability, surface tension and toxicity to permit printing high-resolution images with excellent durability on substrates that can be used to manufacture products suitable for skin contact.

A further object of the present invention is to provide a non-woven textile substrate which is at least partially coated with an ink layer. The printed substrate should have good performance properties, in particular these stated before, and should be used in further processing without any difficulties.

### Technical solution

This problem is solved by the subject matter claimed in the claims and also by the preferred embodiments of that subject matter described in the description hereinafter.

A first subject of the present invention is therefore a method for coating a non-woven textile substrate (S) at least partially with an ink layer (IL), said method comprising:
(1) providing the non-woven textile substrate (S);
(2) optionally pretreating the non-woven textile substrate (S);
(3) depositing at least one ink composition (AC), preferably an aqueous ink composition (AC), over at least a portion of at least one surface of the non-woven textile substrate (S), the ink composition (AC) comprising:
   (i) at least an aqueous dispersion of a polyurethane (meth)acrylate polymer,
   (ii) at least one pigment and/or dye, and
   (iii) optionally at least one photoinitiator;
(4) drying and/or at least partially curing the deposited ink composition (AC) on the non-woven textile substrate (S) obtained after step (3).

A further subject of the present invention is a non-woven textile substrate (S) at least partially coated with an ink layer (IL), said substrate being produced by the inventive method.

The inventive method renders it possible to print images on non-woven substrates in a high resolution of 100 dpi or more without negatively influencing the properties or the haptic of the substrate. The printed images are long lasting, durable, abrasion resistant, water-, detergent- and chemical-fast and do not wear out rapidly upon use, handling, washing and exposure to the environment. Moreover, they are non-toxic and flexible. Additionally, the printed substrates can be used in further processing without complex treatments directly after printing.

The non-toxicity of the ink layer is obtained by using radiation-curing printing inks which are free of ethylenically unsaturated monomers such as (meth)acrylates, because unwanted migration of residual monomers from the cured ink layer into the substrate may lead to skin irritation and/or odor nuisance.

### DETAILED DESCRIPTION

If reference is made in the context of the present invention to an official standard, this of course means the version of the standard that was current on the filing date, or, if no current version exists at that date, then the last current version.

### Inventive Method

According to the inventive method, a non-woven textile substrate (S) is at least partially coated with an ink layer (IL) by depositing a specific ink composition (AC) over at least a portion of at least one surface of the substrate and drying and/or curing the ink.

The term “non-woven textile” denotes a textile which is neither yarn-spun nor woven or knitted. It is a fabric-like material that can be produced from short or long fibers which are bonded together by chemical, mechanical, heat or solvent treatment. In order to increase the strength, these textiles can be densified or reinforced by a backing.

In this description of the invention, for convenience, “polymer” and “resin” are used interchangeably to encompass resins, oligomers, and polymers.

The term “poly(meth)acrylate” stands both for polyacrylates and for polymethacrylates. Poly(meth)acrylates may therefore be constructed of acrylates and/or methacrylates and may contain further ethylenically unsaturated monomers such as, for example, styrene or acrylic acid. The term “(meth)acryloyl” in the sense of the present invention embraces methacryloyl compounds, acryloyl compounds and mixtures thereof.

In the context of this invention, C₁-C₄-alkyl means methyl, ethyl, isopropyl, n-propyl, n-butyl, isobutyl, sec-butyl and tert-butyl, preferably methyl, ethyl and n-butyl, more preferably methyl and ethyl and most preferably methyl.

### Step (1)

In step (1) of the process of the invention, a non-woven textile substrate (S) is provided. The non-woven substrate may either be entirely made of non-woven material or may comprise, at least on one of its surfaces, a coating made of non-woven material. In the latter case, the core of the substrate can be made of glass, ceramic, metal, wood and/or plastic. The substrate used may be an article which has already been shaped, such as, for example, the part of a shoe such as an insole and/or outer sole and/or quarter and/or heel and/or vamp, or a part of a clothing item. Alternatively, the substrate may also be unshaped. In this case, shaping of the substrate may take place after the inventive printing process.

In principle, non-woven textile substrates used in the inventive process can be selected from staple non-woven textiles, melt-blown non-woven textiles, spunlaid non-woven textiles and flashspun non-woven textiles.

Staple nonwovens are normally made in four steps. Fibers are first spun, cut to a few centimeters in length, and put into bales. The staple fibers are then blended, “opened” in a multistep process, dispersed on a conveyor belt, and spread in a uniform web by a wetlaid, airlaid, or carding/crosslapping process. Wetlaid operations typically use 0.25 to 0.75 in (0.64 to 1.91 cm) long fibers, but sometimes longer if the fiber is stiff or thick. Airlaid processing generally uses 0.5 to 4.0 in (1.3 to 10.2 cm) fibers. Carding operations typically use ˜1.5″ (3.8 cm) long fibers. Staple nonwovens are bonded either thermally or by using resin. Bonding can be throughout the web by resin saturation or overall thermal bonding or in a distinct pattern via resin printing or thermal spot bonding.

Melt-blown non-woven textiles are produced by extruding melted polymer fibers through a spin net or die consisting of up to 40 holes per inch to form long thin fibers which are stretched and cooled by passing hot air over the fibers as they fall from the die. The resultant web is collected into rolls and subsequently converted to finished products. The extremely fine fibers differ from other extrusions, particularly spun bond, in that they have low intrinsic strength but much smaller size offering key properties. Often melt blown non-woven textiles and spunbond non-woven textiles are combined in order to increase strength but keep the intrinsic benefits of fine fibers.

Spunlaid, also called spunbond, non-woven textiles are made in one continuous process. Fibers are spun and then directly dispersed into a web by deflectors by air streams. This technique leads to faster belt speeds, and cheaper costs. Spunlaid is bonded by using resin, thermally or by hydroentanglement.

Flashspun fabric is a non-woven fabric formed from fine fibrillation of a film by the rapid evaporation of solvent and subsequent bonding during extrusion. For example, a pressurized solution of a polymer, such as TPU, HDPE or polypropylene in a solvent such as fluoroform is heated, pressurized and pumped through a hole into a chamber.

When the solution is allowed to expand rapidly through the hole the solvent evaporates to leave a highly oriented non-woven network of fibers.

The non-woven textile substrate or—if a coated substrate is used—the layer located on the surface of the substrate consists preferably of at least one thermoplastic polymer, more particularly selected from the group consisting of polymethyl (meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, preferably polyesters such as PBT and PET, polyamides, polyolefins such as polyethylene, polypropylene, polystyrene, and polybutadiene, polyacrylonitrile, polyacetal, polyacrylonitrile-ethylene-propylene-diene-styrene copolymers (A-EPDM), polyetherimides, phenolic resins, urea resins, melamine resins, alkyd resins, epoxy resins, polyurethanes including TPU, polyetherketones, polyphenylene sulfides, polyethers, polyvinyl alcohols, and mixtures thereof and/or glass fibers.

Particularly preferred non-woven textile substrates (S) or layers located on the surface thereof are selected from the group consisting of thermoplastic polyurethanes, polypropylene, glass fibers and mixtures thereof, preferably thermoplastic polyurethane (TPU).

The preparation of thermoplastic polyurethane (also called TPU hereinafter) requires a mixture of at least one polyisocyanate and at least one compound having at least one isocyanate-reactive group. The further addition of chain-extending agents, chain transfer agents, additives and catalysts is optional and can take place individually or in all possible variations. The thermoplastic polyurethane is therefore preferably prepared by reacting
a) at least one polyisocyanate,
b) at least one compound having at least one isocyanate-reactive group,
c) optionally at least one chain extending compound,
d) optionally at least one chain transfer agent and
e) optionally at least one additive
f) optionally in the presence of at least one catalyst.

The polyisocyanate a) is preferably selected from aliphatic, cycloaliphatic and/or aromatic polyisocyanates, more preferably aliphatic, cycloaliphatic and/or aromatic diisocyanates, even more preferably aromatic diisocyanates, very preferably 4,4′-diphenylmethane diisocyanate and/or hexamethylene diisocyanate. Examples of further preferred diisocyanates are trimethylene diisocyanate, tetramethylene diisocyanate, pentamethylene diisocyanate, heptamethylene diisocyanate, octamethylene diisocyanate, 2-methyl-1,5-pentamethylene diisocyanate, 2-ethyl-1,4-butylene diisocyanate, 1,5-pentamethylene diisocyanate, 1,4-butylene diisocyanate, 1-isocyanato-3,3,5-trimethyl-5-isocyanatomethyl-cyclohexane, 1,4-bis(isocyanato-methyl)cyclohexane, 1,3-bis(isocyanatomethyl)cyclo-hexane, 1,4-cyclohexane diisocyanate, 1-methyl-2,4-cyclohexane diisocyanate, 1-methyl-2,6-cyclohexane diisocyanate, 2,2′-dicyclohexylmethane diisocyanate, 2,4′-dicyclohexylmethane diisocyanate, 4,4′-dicyclo-hexylmethane diisocyanate, 2,2′-diphenylmethane diisocyanate, 2,4′-diphenylmethane diisocyanate, 1,5-naphthylene diisocyanate, 2,4-tolylene diisocyanate, 2,6-tolylene diisocyanate, diphenylmethane diisocyanate, 3,3′-dimethylbiphenyl diisocyanate, 1,2-diphenylethane diisocyanate, phenylene diisocyanate and mixtures thereof.

In addition to the at least one polyisocyanate a), the thermoplastic polyurethane (TPU) is made from at least one compound having at least one isocyanate-reactive group b). Preferred compounds b) have an average functionality of 1.8 to 2.3, preferably of 1.9 to 2.2, very preferably of 2, wherein the isocyanate-reactive groups are selected from hydroxy groups, amine groups and thiol groups, preferably hydroxy groups. Mixtures of two or more compounds of such or other functionalities and in such ratios that the average functionality of the compound b) lies in the above stated ranges may also be used. Therefore, small amounts of trifunctional polyhydroxy compounds may be present as well in order to achieve the desired average functionality of the compound b). Compounds b) preferably have a molecular weight of 500 to 10.000 g/mol, as determined by gel permeation chromatography. In case of oligomers and polymers, the molecular weight is corresponding to the weight average molecular weight M.

Particularly preferred compounds b) are selected from the group consisting of polyesteramides, polythioethers, polycarbonates, polyacetals, polyolefins, polysiloxanes, polybutadienes, polyesters polyols, polyether polyols and mixtures thereof, preferably polyether diols, polyester diols, polycarbonate diols and mixtures thereof, very preferably polyether diols and/or polyester diols. Other dihydroxy compounds such as hydroxyl-ended styrene block copolymers like SBS, SIS, SEBS or SIBS may be used as well. The compound b) preferably has a molecular weight M_{w} of 500 to 8,000 g/mol, more preferably of 600 to 6,000 g/mol and especially of 800 to 4,000 g/mol, as determined by gel permeation chromatography.

It is particularly preferable to use polyether diols. Suitable polyetherols can be prepared by known methods, for example from one or more alkylene oxides having from 2 to 4 carbon atoms in the alkylene radical and, if appropriate, an initiator molecule containing two reactive hydrogen atoms in bound form by anionic polymerization using alkali metal hydroxides such as sodium or potassium hydroxide or alkali metal alkoxides such as sodium methoxide, sodium or potassium ethoxide or potassium isopropoxide as catalysts or by cationic polymerization using Lewis acids such as antimony pentachloride, boron fluoride etherate, etc., or bleaching earth as catalysts. Examples of alkylene oxides are: ethylene oxide, 1,2-propylene oxide, tetrahydrofuran, 1,2- and 2,3-butylene oxide. Preference is given to using ethylene oxide and mixtures of 1,2-propylene oxide and ethylene oxide. The alkylene oxides can be used individually, alternately in succession or as mixtures. Examples of suitable initiator molecules are: water, amino alcohols such as N-alkyldialkanolamines, for example N-methyldiethanolamine, and diols, e.g. alkanediols or dialkylene glycols having from 2 to 12 carbon atoms, preferably from 2 to 6 carbon atoms, for example ethanediol, 1,3-propanediol, 1,4-butanediol and 1,6-hexanediol. If desired, it is also possible to use mixtures of initiator molecules.

Suitable polyether diols can also contain low unsaturation levels (i.e. less than 0.1 milliequivalents per gram diol). Other diols which may be used comprise dispersions or solutions of addition or condensation polymers in diols of the types described above. Such modified diols, often referred to as ‘polymer’ diols have been fully described in the prior art and include products obtained by the in-situ polymerization of one or more vinyl monomers, for example styrene and acrylonitrile, in polymeric diols, for example polyether diols, or by the in-situ reaction between a polyisocyanate and an amino- and/or hydroxy-functional compound, such as triethanolamine, in a polymeric diol.

Especially useful polyether diols are derived from 1,2-propylene oxide and ethylene oxide in which more than 50%, preferably from 60 to 80%, of the OH groups are primary hydroxyl groups and in which at least part of the ethylene oxide is arranged as a terminal block. In this respect, random copolymers having oxyethylene contents of 10 to 80%, block copolymers having oxyethylene contents of up to 25% and random/block copolymers having oxyethylene contents of up to 50%, based on the total weight of oxyalkylene units, may be mentioned. Such polyetherols can be obtained by, for example, first polymerizing the 1,2-propylene oxide onto the initiator molecule and subsequently polymerizing on the ethylene oxide or first copolymerizing all the 1,2-propylene oxide with part of the ethylene oxide and subsequently polymerizing on the remainder of the ethylene oxide or, stepwise, first polymerizing part of the ethylene oxide onto the initiator molecule, then polymerizing on all of the 1,2-propylene oxide and then polymerizing on the remainder of the ethylene oxide.

Further especially useful polyether diols are the hydroxyl-containing polymerization products of tetrahydrofuran (polyoxytetramethylene glycols). Particularly preferred polyether diols are therefore linear polyether diols selected from the group consisting of polyoxytetramethylene glycols, polyether diols based on 1,2-propylene oxide, polyether diols based on ethylene oxide and mixtures thereof, wherein said polyether diols have a molecular weight M_{w} between 800 g/mol and 2,500 g/mol as determined by gel permeation chromatography.

In an alternative particularly preferred embodiment, a polyester diol is used to prepare the thermoplastic polyurethane. Such polyester diols can be prepared, for example, from dicarboxylic acids having from 2 to 12 carbon atoms, preferably from 4 to 8 carbon atoms, and polyhydric alcohols. Examples of suitable dicarboxylic acids are: aliphatic dicarboxylic acids such as succinic acid, glutaric acid, suberic acid, azelaic acid, sebacic acid and preferably adipic acid and aromatic dicarboxylic acids such as phthalic acid, isophthalic acid and terephthalic acid. The dicarboxylic acids can be used individually or as mixtures, e.g. in the form of a succinic, glutaric and adipic acid mixture. Likewise, mixtures of aromatic and aliphatic dicarboxylic acids can be used. To prepare the polyester diols, it may be advantageous to use the corresponding dicarboxylic acid derivatives such as dicarboxylic esters having from 1 to 4 carbon atoms in the alcohol radical, dicarboxylic anhydrides or dicarboxylic acid chlorides instead of the dicarboxylic acids. Examples of polyhydric alcohols are alkanediols having from 2 to 10, preferably from 2 to 6, carbon atoms, e.g. ethanediol, 1,3-propanediol, 1,4-butanediol, 1,5-pentanediol, 1,6-hexanediol, 1,10-decanediol, 2,2-dimethylpropane-1,3-diol and 1,2-propanediol and dialkylene ether glycols such as diethylene glycol and dipropylene glycol. Depending on the desired properties, the polyhydric alcohols can be used alone or, if desired, as mixtures with one another.

Also suitable are esters of carbonic acid with the abovementioned diols, in particular those having from 4 to 6 carbon atoms, e.g. 1,4-butanediol and/or 1,6-hexanediol, condensation products of (ω-hydroxycarboxylic acids, for example ω-hydroxycaproic acid, and preferably polymerization products of lactones, for example substituted or unsubstituted ω-caprolactones.

Polyester diols which are preferably used are selected from the group consisting of alkanediol polyadipates having from 2 to 6 carbon atoms in the alkylene radical, preferably ethanediol polyadipates, 1,4-butanediol polyadipates, ethanediol-1,4-butanediol polyadipates, 1,6-hexanediol-neopentyl glycol polyadipates, polycaprolactones and mixtures thereof, very preferably 1-4-butanediol polyadipates and/or 1,6-hexanediol-1,4-butanediol polyadipates.

The polyester diols preferably have molecular weights (weight average) of 500 to 6,000 g/mol, more preferably from 600 to 3,500 g/mol, very preferably 600 to 2,000 g/mol, as determined by gel permeation chromatography.

When thermoplastic polyetheresters and/or polyesteresters are used, these are obtainable according to any common literature method by esterification or transesterification of aromatic and aliphatic dicarboxylic acids of 4 to 20 carbon atoms and, respectively, esters thereof with suitable aliphatic and aromatic diols and polyols (cf. for example “Polymer Chemistry”, Interscience Publ., New York, 1961, pp. 111-127; Kunststoffhandbuch, volume VIII, C. Hanser Verlag, Munich 1973 and Journal of Polymer Science, Part A1, 4, pages 1851-1859 (1966)).

Useful aromatic dicarboxylic acids include, for example, phthalic acid, isophthalic acid and terephthalic acid or, respectively, esters thereof. Useful aliphatic dicarboxylic acids include, for example, 1,4-cyclohexanedicarboxylic acid, adipic acid, sebacic acid, azelaic acid, and decanedicarboxylic acid as saturated dicarboxylic acids and also maleic acid, fumaric acid, aconitic acid, itaconic acid, tetrahydrophthalic acid and tetrahydroterephthalic acid as unsaturated dicarboxylic acids.

Useful diol components include for example:
diols of general formula HO—(CH₂)ₙ—OH, where n=2 to 20, such as ethylene glycol, 1,3-propanediol, 1,4-butanediol or 1,6-hexanediol,
polyetherols of general formula HO—(CH₂)ₙ—O—(CH₂)ₘ—OH, where n and m are each 2 to 20 and n and m may be the same or different,
unsaturated diols and polyetherols such as, for example, 1,4-butenediol,
diols and polyetherols comprising aromatic units,
polyesterols.

In addition to the recited carboxylic acids and esters thereof and also the recited alcohols, any further common representatives of these classes of compounds can be used for providing the polyetheresters and polyesteresters used with preference.

Hard phases are typically formed from aromatic dicarboxylic acids and short-chain diols, while soft phases are formed from ready-formed aliphatic, difunctional polyesters having a molecular weight between 500 and 3,000 g/mol.

When polyesteresters are used, it is preferable to use products of the Pelprene® type from Tojobo (e.g., Pelprene® S1001 or Pelprene® P70B). When polyetheresters are used, it is preferable to use products of the Elastotec® type from BASF (e.g., Elastotec® A 4512), of the Arnitel® type from DSM (e.g., Arnitel® PL380 or Arnitel® EB463), of the Hytrel® type from DuPont (e.g., Hytrel® 3078), of the Riteflex® type from Ticona (e.g., Riteflex® 430 or Riteflex® 635) or of the Ecdel® type from Eastman Chemical (e.g., Ecdel® Elastomer 9965 or Ecdel® Elastomer 9965).

Polycarbonate diols which may be used include those prepared by reacting glycols such as diethylene glycol, triethylene glycol or hexanediol with formaldehyde. Suitable polyacetals may also be prepared by polymerizing cyclic acetals.

The thermoplastic polyetheramides are obtainable according to any common, known literature method via reaction of amines and carboxylic acids, or esters thereof, or other derivatives. Amines and/or carboxylic acids in this case further comprise ether units of the R—O—R type, where R is an aliphatic and/or aromatic organic radical. Monomers selected from the following classes of compounds are used in general:
HOOC—R′—NH₂, where R′ may be aromatic and aliphatic and preferably comprises ether units of the R—O—R type. R therein is an aliphatic and/or aromatic organic radical,
aromatic dicarboxylic acids, for example phthalic acid, isophthalic acid and terephthalic acid, or esters thereof, and also aromatic dicarboxylic acids comprising ether units of the R—O—R type, where R is an aliphatic and/or aromatic organic radical,
aliphatic dicarboxylic acids, for example 1,4-cyclohexanedicarboxylic acid, adipic acid, sebacic acid, azelaic acid, and decanedicarboxylic acid as saturated dicarboxylic acids and also maleic acid, fumaric acid, aconitic acid, itaconic acid, tetrahydrophthalic acid and tetrahydroterephthalic acid as unsaturated dicarboxylic acids, and also aliphatic dicarboxylic acids comprising ether units of the R—O—R type, where R is an aliphatic and/or aromatic organic radical,
diamines of general formula H₂N—R″—NH₂, where R″ may be aromatic and aliphatic and preferably comprises ether units of the R—O—R type, where R is an aliphatic and/or aromatic organic radical,
lactams, for example ε-caprolactam, pyrrolidone or laurolactam, and also
amino acids.

In addition to the recited carboxylic acids and esters thereof and also the recited amines, lactams and amino acids, any further common representatives of these classes of compounds can be used for providing a polyetheramine used with preference. Also known are mixed products of polytetrahydrofuran and amide synthons.

When polyetheram ides are used, it is preferable to use products of the Pebax® type from Arkema (e.g., Pebax® 2533 or Pebax® 3533) or of the Vestamid® type from Evonik (e.g., Vestamid® E4083).

Polythioether diols which may be used include products obtained by condensing thiodiglycol either alone or with other glycols, alkylene oxides, dicarboxylic acids, formaldehyde, amino-alcohols or aminocarboxylic acids.

Suitable polyolefin diols include hydroxy-terminated butadiene homo- and copolymers and suitable polysiloxane diols include polydimethylsiloxane diols.

When the thermoplastic polyurethane is prepared using chain extenders c), these are preferably aliphatic, araliphatic, aromatic and/or cycloaliphatic compounds which preferably have a molecular weight of 50 to 500 g/mol, more preferably 60 to 300 g/mol. Suitable chain extenders c) are for example alkanediols having from 2 to 12 carbon atoms, preferably 2,4 or 6 carbon atoms, e.g. ethanediol, 1,6-hexanediol and in particular 1,4-butanediol, and dialkylene ether glycols such as diethylene glycol and dipropylene glycol. However, other suitable chain extenders are diesters of terephthalic acid with alkanediols having from 2 to 4 carbon atoms, e.g. bis(ethanediol) terephthalate or bis(1,4-butanediol)terepthalate, hydroxyalkylene ethers of hydroquinone such as 1,4-di(β-hydroxyethyl)hydroquinone, (cyclo)aliphatic diamines such as 4,4′-diaminodicyclohexylmethane, 3,3′-dimethyl-4,4′-diaminodicyclo-hexylmethane, 1-amino-3,3,5-trimethyl-5-aminomethylcyclohexane, ethylenediamine, 1,2- and 1,3-propylenediamine, N-methylpropylene-1,3-diamine and N,N′-dimethylethylenediamine and aromatic diamines such as 2,4- and 2,6-toluenediamine, 3,5-diethyl-2,4- and -2,6-toluenediamine and primary, ortho-dialkyl-, -trialkyl- and/or -tetraalkyl-substituted 4,4′-diaminodiphenylmethanes. If desired, it is also possible to use mixtures of chain extenders c).

Preferred chain extenders c) are alkanediols having from 2 to 6 carbon atoms in the alkylene radical, more preferably 1,4-butanediol and/or dialkylene glycols having from 4 to 8 carbon atoms.

To set the Shore hardness of thermoplastic polyurethanes compound b) and the at least one chain extender c) can be varied within relatively wide molar ratios. In preferred embodiments the molar ratio of the at least one compound b) to the at least one chain extender c) in the range from 10:1 to 1:10, preferably in the range from 5:1 to 1:8, more preferably in the range from 1:1 to 1:6.4, very preferably in the range from 1:1 to 1:4. The hardness and the vicat softening temperature or the melting point of the thermoplastic polyurethane increases with increasing amounts of chain extender c).

When chain transfer agents d) are used, these typically have a molecular weight of 30 to 500 g/mol. Chain transfer agents are compounds that only have one isocyanate-reactive group. Examples of chain transfer agents are monofunctional alcohols and/or monofunctional amines, preferably methylamine and/or monofunctional polyols. Chain transfer agents can be used to specifically control the flow characteristics of mixtures of the individual components. Chain transfer agents in preferred embodiments are used in an amount of 0 part by weight to 5 parts by weight and more preferably in the range from 0.1 part by weight to 1 part by weight, based on 100 parts by weight of compound b). Chain transfer agents can be used in addition to or instead of chain extenders.

In further preferred embodiments, the reaction to form the thermoplastic polyurethane is carried out at customary indices. The index is defined as the ratio of the total number of isocyanate groups of the aromatic, aliphatic and/or cycloaliphatic diisocyanate a) to the total number of isocyanate-reactive groups, i.e., the number of active hydrogens in compound b), chain extender c) and chain transfer agent d). If the index is 1, there is one active hydrogen atom, i.e. one isocyanate-reactive group, in components b), c) and d) for each isocyanate group in component a). If indices are above 1, there are more isocyanate groups than isocyanate-reactive groups present. In particularly preferred embodiments the reaction to form the thermoplastic polyurethane takes place at an index between 0.6 and 1.2 and more preferably at an index between 0.8 and 1.1.

Particularly preferred thermoplastic polyurethanes are obtained by reacting:
(a) diphenylmethane 4,4′-diisocyanate (MDI) and/or hexamethylene diisocyanate,
(b) polyoxytetramethylene glycol, polyether diols based on 1,2-propylene oxide and ethylene oxide and/or polyester diols based on alkanediol polyadipates having from 2 to 6 carbon atoms in the alkylene radical and
(c) 1,2-ethanediol, 1,4-butanediol and/or 1,6-hexanediol,
wherein the ratio of the isocyanate groups of the component (a) to the sum of the isocyanate-reactive groups of the components (b) and (c) is preferably from 1:0.8 to 1:1.1 and (b) and (c) are used in a molar ratio of 1:1 to 1:6.4.

Further embodiments utilize at least one catalyst f) to catalyze in particular the reaction between the isocyanate groups of the diisocyanates and the isocyanate-reactive compounds, preferably hydroxyl groups, of the compound b) having at least two isocyanate-reactive groups, the chain transfer agents c) and the chain extenders d). In preferred embodiments, the catalyst is selected from the group of tertiary amines, for example triethylamine, dimethylcyclohexylamine, N-methylmorpholine. N,N′-dimethyl-piperazine, 2-(dimethylaminoethoxy)ethanol, diazabicyclo(2,2,2)octane and similar substances. In further preferred embodiments, the at least one catalyst is selected from the group of organometallic compounds and is, mentioned by way of example, a titanic ester, an iron compound, for example iron(III) acetylacetonate, a tin compound, for example tin diacetate, tin dioctoate, tin dilaurate or a tin dialkyl salt of an aliphatic carboxylic acid such as dibutyltin diacetate, dibutyltin dilaurate or the like.

Some embodiments utilize the catalysts individually, while other embodiments utilize mixtures of catalysts. The catalyst used in one preferred embodiment is a mixture of catalysts in amounts of 0.0001 wt. % to 0.1 wt. %, based on compound b).

Apart from catalysts, customary auxiliaries and/or additives e) can also be added to the formative components a) to d). Examples which may be mentioned are hydrolysis-control agents, phosphorus compounds, surface-active substances, flame retardants, nucleating agents, oxidation inhibitors, stabilizers, lubricants and mold release agents, dyes and pigments, inhibitors, stabilizers against hydrolysis, light, heat or discoloration, inorganic and/or organic fillers, reinforcing materials and plasticizers.

Suitable hydrolysis control agents are, for example polymers and low molecular weight carbodiimides and/or epoxides.

Suitable organophosphorus compounds are selected from trivalent phosphorus, for example phosphites and phosphonites. Examples of suitable phosphorus compounds are triphenyl phosphites, diphenyl alkyl phosphite, phenyl dialkyl phosphite, tris(nonylphenyl) phosphite, trilauryl phosphite, trioctadecyl phosphite, distearylpentaerythritol disphosphite, tris(2,4-di-tert-butylphenyl) phosphite, diisodecylpentaerythritol diphosphite, di(2,4-di-tert-butylphenyl)pentaerythritol diphosphite, tristearylsorbitol triphosphite, tetrakis(2,4-di-tert-butylphenyl)-4,4′-biphenylylene diphosphonite, triisodecyl phosphite, diisodecyl phenyl phosphite and diphenyl isodecyl phosphite or mixtures thereof. Particularly phosphorus compounds are such compounds, which are difficult to hydrolyze, since the hydrolysis of a phosphorus compound to the corresponding acid can lead to damage being inflicted on the polyurethane, especially the polyester urethane. Accordingly, phosphorus compounds that are particularly difficult to hydrolyze are suitable for polyester urethanes in particular. Preferred embodiments of difficult-to-hydrolyze phosphorus compounds are dipolypropylene glycol phenyl phosphite, diisodecyl phosphite, triphenylmonodecyl phosphite, triisononyl phosphite, tris(2,4-di-tert-butylphenyl) phosphite, tetrakis(2,4-di-tert-butylphenyl)-4,4′-biphenylene and di(2,4-di-tert-butylphenyl)pentaerythritol diphosphite or mixtures thereof.

If desirable, up to 10% by weight of a color pigment or color batch, based on the total weight of the TPU, can be added in order to color the TPU. Suitable pigments may be chromatic, white and black pigments (color pigments) and inorganic pigments typically used as fillers. Suitable organic pigments are, for example, monoazo pigments, diazo pigments, anthraquinone pigments, benzimidazole pigments, quinacridone pigments, quinophthalone pigments, diketopyrrolopryrrole pigments, dioxazine pigments, indanthrone pigments, isoindoline pigments, isoindoline pigments, metal complex pigments, perinone pigments, perylene pigments, phthalocyanine pigments, aniline black and mixtures thereof. Suitable inorganic pigments are, for example, titanium dioxide, zinc white, zinc sulfide, lithopone, black iron oxide, iron manganese black, spinel black, carbon black, ultramarine green, ultramarine blue, manganese blue, ultramarine violet, red iron oxide, molybdate red, ultramarine, brown iron oxide, mixed brown, spinel and corundum phases, yellow iron oxide, bismuth vanadate and mixtures thereof. As examples of inorganic pigments typically used as fillers may be mentioned are transparent silicon dioxide, ground quartz, alumina, aluminum hydroxide, natural micas, natural and precipitated chalk, and barium sulfate.

The TPU can further contain 0.1 to 3% by weight of an UV light absorber and/or 0.1 to 5% by weight of a light stabilizer, based on the total weight of the TPU in each case. Suitable UV light absorbers are, for example, benzotriazoles. HALS compounds can be used as suitable UV light stabilizers.

Moreover, the TPU can contain 0, 0.05 to 2% by weight, based on the total weight of the TPU, of an antioxidant such as phenolic antioxidants.

If desired, also 0.3 to 5% by weight, based on the total weight of the TPU, of a lubricant and/or processing aid selected from the group of ester waxes, polyolefin waxes, metallic soaps, amide waxes, fatty acid amides or their mixtures can be incorporated. However, preferred non-textile TPU substrates do not contain such lubricants and/or processing aids, i.e. preferred TPU substrates contain 0% by weight, based on the total weight of the TPU, of a lubricant and/or processing aid in order to increase the adhesion of the printing ink to the substrate.

Suitable flame retardants, for example inorganic hydroxides, such as aluminum hydroxide, inorganic phosphates such as ammonium polyphosphate or organic nitrogen compounds such as melamine or melamine derivatives, can also be contained in the TPU

The TPUs suitable for producing non-woven substrates can be obtained by the so-called one-shot, semi-prepolymer or prepolymer method, by casting, extrusion or any other process known to the person skilled in the art and are generally supplied as granules or pellets.

Optionally, small amounts, i.e. up to 30, preferably 20 and most preferably 10, weight %, based on the total weight of the blend, of other conventional thermoplastic elastomers such as PVC, EVA or TR may be blended with the TPU.

Particularly suitable TPUs have the following characteristics:
a shore hardness, as determined according to DIN ISO 7619-1:2012-02 using a measuring time of 3 s, from A44 to D80, more preferably from A50 to A99, even more preferably from A60 to A95, very preferably from A70 to A90, especially preferably A80 or A83, and/or
a vicat softening temperature, as determined according to DIN EN ISO 306:2014-03 using a heating rate of 120° C./h and a load of 10N, of 40 to 160° C., more preferably of 50 to 130° C., very preferably of 80 to 120° C., and/or
a glass transition temperature Tg, as determined according to DIN EN ISO 11357-1:2017-02 with a heating rate of 10° C./min, of −100 to 20° C., more preferably of −80 to 20° C., even more preferably of −60 to 0° C., very preferably of −44° C., and/or
a tensile strength, as determined according to DIN 53504:2009-10 using tension bar S2, of 10 to 60 MPa, more preferably of 20 to 60 MPa, even more preferably of 30 to 60 MPa, very preferably of 45 MPa or 55 MPa, and/or
an elongation at break, as determined according to DIN 53504:2009-10 using tension bar S2, of 300 to 1,300%, preferably of 400 to 1,000%, even more preferably of 500 to 800%, very preferably of 600% or 650%, and/or
a tear resistance, as determined according to DIN EN ISO 34-1:2004-07 using method B, procedure (a), of 27 to 240 kN/m, more preferably of 30 to 150 kN/m, even more preferably of 40 to 100 kN/m, very preferably of 55 kN/m or 75 kN/m, and/or
an abrasion loss, as determined according to DIN EN ISO 4649:2010-09 using Method A, of 25 to 165 mm³, more preferably of 25 to 100 mm³, even more preferably of 25 to 50 mm³, very preferably of 30 mm³ or 35 mm³.

Non-woven textile substrates (S) preferably used according to the present invention have a base weight of 50 to 1,000 g/m², more preferably of 80 to 700 g/m², even more preferably of 100 to 500 g/m², very preferably of 400 to 500 g/m².

### Step (2)

In optional step (2) of the inventive method, the non-woven textile substrate (S) is pretreated.

By pretreatment, the absorbency of the substrate used can be adapted so that for example excessive penetration of the ink into the substrate, which may lead to unwanted stiffness of the substrate after curing, is prevented. Pretreatment can also increase adhesion of the ink to the substrate, thus increasing resolution of the printed image.

Preferably, the non-woven textile substrate (S) is pretreated by application of at least one primer composition. This increases the adhesion of the ink composition (AC) to the substrate (S) covered with such a primer composition. Suitable primer compositions are known in the art and can be aqueous, solvent-based or 100% solids primer compositions. Such compositions comprise at least one resin which can be selected from (meth)acrylates, polyurethanes, epoxides and radiation curable polymers and/or oligomers and mixtures thereof. In this case, the ink composition (AC) is applied onto the substrate (S) coated with the primer composition. The primer composition can be dried and/or at least partially cured before the ink composition (AC) is applied.

### Step (3)

In step (3) of the process of the invention, at least one specific ink composition (AC) is deposited over at least a portion of at least one surface of the non-woven textile substrate (S) obtained after step (1) or (2).

Preferably, the ink composition (AC) is directly deposited on at least one surface of the non-woven textile substrate (S). Direct application of ink composition (AC) to the non-woven textile substrate (S) results in direct contact of the ink composition (AC) and the non-woven textile substrate (S). Thus, there is no other layer, preferably no primer layer, disposed between the ink composition (AC) and the substrate (S).

If an article which has already been shaped or a substrate comprising an appropriate thickness is used, this substrate comprises four surfaces where printing is possible. In this case, it can be advantageous if the ink composition (AC) is deposited on more than one surface of the substrate. This is especially preferred if the image to be printed with the ink composition (AC) is to be positioned on at least two surfaces of the substrate. Therefore, according to a preferred embodiment of step (3) of the present invention, the ink composition (AC) is deposited on at least two surfaces of the non-woven textile substrate (S).

### Ink composition (AC)

The ink composition (AC) used in step (3) of the inventive process comprises as mandatory components at least one aqueous dispersion of a polyurethane (meth)acylate polymer (i) and at least one pigment (ii). If the printing ink is cured by UV light, it further comprises at least one photoinitiator (iii). The ink composition (AC) used in the inventive process can be aqueous, solvent-borne or a high solid (i.e. having a solid content of more than 40% but less than 100%) ink composition. Preferably, the ink composition (AC) is an aqueous ink composition.

### Aqueous Dispersion of a Polyurethane (meth)acrylate Polymer (i) Preferred polyurethane (meth)acrylate polymers are obtained by reaction of:

(a) at least one (cyclo)aliphatic di- and/or polyisocyanate,
(b1) at least one (cyclo)aliphatic diol having a molar mass of less than 700 g/mol,
(b2) at least one polyester diol having a weight-average molar mass M_{w} of 700 to 2000 and preferably an acid number to DIN 53240-2:2007-11 of not more than 20 mg KOH/g,
(c) at least one compound having at least one isocyanate-reactive group and at least one free-radically polymerizable unsaturated group,
(d) at least one compound having at least one isocyanate-reactive group and at least one acid group,
(e) at least one base of an alkali metal for at least partial neutralization of the acid groups of component (d),
(f) optionally at least one monoalcohol having exactly one hydroxyl function, or at least one mono- and di-C₁-C₄-alkylamine, and
(g) at least one monofunctional polyalkylene oxide polyether alcohol.

Component (a) is at least one, preferably one to four, more preferably one to three, (cyclo)aliphatic di- and/or polyisocyanates. These are monomers and/or oligomers of aliphatic or cycloaliphatic diisocyanates. The NCO functionality of such a compound is generally at least 1.8 and may be up to 8, preferably 1.8 to 5, and more preferably 2 to 4. The di- and polyisocyanates which can be used preferably have an isocyanate group (calculated as NCO, molecular weight=42) content of 10 to 60% by weight, based on the di- and polyisocyanate (mixture), preferably 15 to 60% by weight and more preferably 20 to 55% by weight.

Preference is given to aliphatic and/or cycloaliphatic di- and polyisocyanates, referred to collectively as (cyclo)aliphatic in the context of this specification, examples being the aliphatic and/or cycloaliphatic diisocyanates stated above, or mixtures thereof.

Component (a) preferably is a mixture of a cycloaliphatic or aliphatic, preferably of an aliphatic, monomeric diisocyanate (a1) and of a polyisocyanate (a2). In this context, component (a1) is preferably selected from the group consisting of hexam ethylene diisocyanate, 1,3-bis(isocyanatomethyl)cyclohexane, isophorone diisocyanate, 4,4′- or 2,4′-di(isocyanatocyclohexyl)methane and mixtures thereof, and more preferably selected from the group consisting of isophorone diisocyanate and hexamethylene diisocyanate, and is most preferably hexamethylene-1,6-diisocyanate.

In this context, component (a2) is preferably a polyisocyanate having isocyanurate groups, a uretdione diisocyanate, a polyisocyanate having biuret groups, a polyisocyanate having urethane or allophanate groups and mixtures thereof.

Most preferably, polyisocyanate (a2) is a polyisocyanate which comprises at least one hydroxyalkyl (meth)acrylate attached via an allophanate group and satisfies the formula (I)

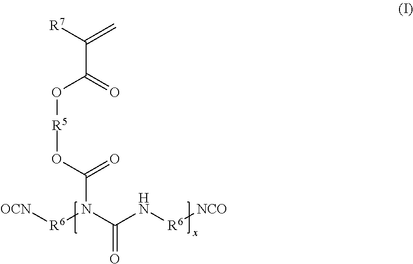

in which R⁵ is a divalent alkylene radical which has 2 to 12 carbon atoms and may optionally be substituted by C₁-C₄-alkyl groups and/or be interrupted by one or more oxygen atoms, preferably having 2 to 10 carbon atoms, more preferably 2 to 8 and most preferably having 3 to 6 carbon atoms, R⁶ is a divalent alkylene radical or cycloalkylene radical which has 2 to 20 carbon atoms and may optionally be substituted by C₁-C₄-alkyl groups and/or be interrupted by one or more oxygen atoms, preferably having 4 to 15 carbon atoms, more preferably having 6 to 13 carbon atoms, hydrogen or methyl, preferably hydrogen, and x is a positive number having a statistical average of 2 up to 6, preferably of 2 to 4.

In a particularly preferred embodiment of the present invention, R⁶ is 1,6-hexylene and R⁵ is selected from the group consisting of 1,2-ethylene, 1,2-propylene and 1,4-butylene, preferably from 1,2-ethylene and 1,4-butylene, and is more preferably 1,2-ethylene. A commercially available polyisocyanate where R⁵=1,2-ethylene, R⁶=1,6-hexylene and R⁷=hydrogen is available under the Laromer® LR 9000 trade name from BASF SE, Ludwigshafen, with an NCO content of 14.5-15.5% by weight.

Component (b1) is at least one, preferably one to three, more preferably one to two and most preferably exactly one (cyclo)aliphatic, especially aliphatic diol(s), having a molar mass of less than 700 g/mol, preferably less than 600, more preferably less than 500 and most preferably less than 400 g/mol. A cycloaliphatic diol is understood to mean those diols comprising at least one saturated ring system.

Preferred diols (b1) are ethylene glycol, propane-1,2-diol, propane-1,3-diol, 2,2-dimethylethane-1,2-diol, 2,2-dimethylpropane-1,3-diol (neopentyl glycol), butane-1,2-diol, butane-1,3-diol, butane-1,4-diol, hexane-1,6-diol or diethylene glycol. Particularly preferred compounds (b1) are ethylene glycol, propane-1,2-diol, propane-1,3-diol, neopentyl glycol, butane-1,4-diol and diethylene glycol. Very particularly preferred compounds (b1) are ethylene glycol, neopentyl glycol and butane-1,4-diol, especially neopentyl glycol.

Component (b2) is at least one, preferably one to three, more preferably one to two and most preferably exactly one polyester diol(s) having a weight-average molar mass M_{w} of 700 to 2,000, preferably 750 to 1,500 g/mol (determined, for example, by gel permeation chromatography (GPC)), preferably having an acid number to DIN 53240-2:2007-11 of not more than 20 mg KOH/g.

It is preferably a polyester diol formed at least partly from cycloaliphatic diol and/or dicarboxylic acid units, more preferably at least partly from cycloaliphatic diol units, and most preferably comprises, as well as any desired dicarboxylic acid units, exclusively cycloaliphatic diols as diol units. Polyester diols of this kind have elevated stiffness compared to those formed from purely aliphatic units. In addition, aliphatic and cycloaliphatic units have a lesser tendency to yellowing compared to purely aromatic units. The dicarboxylic acid units may be the free acids or derivatives thereof.

Derivatives are preferably understood to mean the corresponding anhydrides in monomeric or else polymeric form, mono- or dialkyl esters, preferably mono- or di-C₁-C₄-alkyl esters, more preferably mono- or dimethyl esters or the corresponding mono- or diethyl esters, or else mono- and divinyl esters, and also mixed esters, preferably mixed esters with different C₁-C₄-alkyl components, more preferably mixed methyl ethyl esters.

Diols used with preference are ethylene glycol, propane-1,2-diol, propane-1,3-diol, butane-1,4-diol, pentane-1,5-diol, hexane-1,6-diol and octane-1,8-diol.

Preferred cycloaliphatic diols are cyclohexane-1,2-, -1,3- and -1,4-diol, 1,3- and 1,4-bis(hydroxymethyl)cyclohexane and bis(4-hydroxycyclohexane)isopropylidene. Examples of aliphatic dicarboxylic acids are oxalic acid, malonic acid, maleic acid, fumaric acid, succinic acid, glutaric acid, adipic acid, pimelic acid, suberic acid, azelaic acid, sebacic acid, undecane-a,ω-dicarboxylic acid, dodecane-a,ω-dicarboxylic acid and derivatives thereof. Examples of cycloaliphatic dicarboxylic acids are cis- and trans-cyclohexane-1,2-dicarboxylic acid (hexahydrophthalic acids), cis- and trans-cyclohexane-1,3-dicarboxylic acid, cis- and trans-cyclohexane-1,4-dicarboxylic acid, 1,2-, 1,3- or 1,4-cyclohex-4-enedicarboxylic acid (tetrahydrophthalic acids), cis- and trans-cyclopentane-1,2-dicarboxylic acid, cis- and trans-cyclopentane-1,3-dicarboxylic acid and derivatives thereof. Examples of aromatic dicarboxylic acids are phthalic acid, isophthalic acid, terephthalic acid and phthalic anhydride, preference being given to phthalic acid and isophthalic acid, particular preference to phthalic acid.

Component (c) is at least one, preferably 1 to 3, more preferably exactly one to two and most preferably exactly one compound(s) having at least one, for example one to three, preferably one to two and more preferably exactly one isocyanate-reactive group(s) and at least one, for example one to five, preferably one to three, more preferably one or two and most preferably exactly one free-radically polymerizable unsaturated group. Isocyanate-reactive groups may, for example, be —OH, —SH, —NH₂ and —NHR⁸ where R⁸ is an alkyl group comprising 1 to 4 carbon atoms, for example methyl, ethyl, n-propyl, isopropyl, n-butyl, iso-butyl, sec-butyl or tert-butyl. Isocyanate-reactive groups may preferably be —OH, —NH₂ or —NHR⁸, more preferably —OH or —NH₂ and most preferably —OH.

In a preferred embodiment, component (c) is selected from the group consisting of 2-hydroxyethyl acrylate, 2-hydroxyethyl methacrylate, 2- or 3-hydroxypropyl acrylate and butane-1,4-diol monoacrylate, 1,2- or 1,3-diacrylate of glycerol, trimethylolpropane diacrylate, pentaerythrityl triacrylate, ditrimethylolpropane triacrylate and dipentaerythrityl pentaacrylate, preferably from 2-hydroxyethyl acrylate and 2-hydroxyethyl methacrylate, preferably 2-hydroxyethyl acrylate.

In a preferred embodiment, at least a portion of compound (c) is attached to the di- or polyisocyanate (a), preferably a polyisocyanate (a2), more preferably via allophanate groups. In this case, the molar ratio of compound (c) attached to a polyisocyanate (a2) to compound (c) which is used in free form in the preparation of the inventive urethane (meth)acrylate is, for example, from 90:10 to 10:90, preferably from 20:80 to 80:20 and more preferably 30:70 to 70:30. It is preferable that the compound (c) attached to a polyisocyanate (a2) and the compound (c) which is used in free form in the preparation of the inventive urethane (meth)acrylate are the same compound (c), but they may also be different compounds (c).

Component (d) is at least one, preferably exactly one, compound having at least one, for example one or two, preferably exactly two, isocyanate-reactive group(s) and at least one acid group. Acid groups are understood to mean carboxylic acid, sulfonic acid or phosphonic acid groups, preferably carboxylic acid or sulfonic acid groups and more preferably carboxylic acid groups. Compound (d) is preferably a compound having exactly two hydroxyl groups and exactly one acid group, preferably exactly one carboxylic acid group. Examples thereof are dimethylolpropionic acid, dimethylolbutyric acid and dimethylolpentanoic acid, preferably dimethylolpropionic acid and dimethylolbutyric acid, a particularly preferred compound (d) being dimethylolpropionic acid.

Component (e) is at least one base of an alkali metal for at least partial neutralization of the acid groups of component (d). Useful basic compounds (e) include alkali metal hydroxides, oxides, carbonates and hydrogen carbonates. Particular preference is given to at least partial, preferably full, neutralization with sodium hydroxide or potassium hydroxide. The amounts of chemically attached acid groups introduced and the extent of the neutralization of the acid groups (which is usually 40 to 100 mol %, preferably 50 to 100 mol %, more preferably 60 to 100, even more preferably 75 to 100 and especially 90 to 100 mol % based on equivalents) should preferably be sufficient to ensure dispersion of the polyurethanes in an aqueous medium, which is familiar to the person skilled in the art. Use of alkali metal hydroxides, oxides, carbonates and hydrogen carbonates results in a high water redispersibility of the polyurethane (meth)acrylate polymer even after drying and before curing because said salts are stable and compatible with water. Such redispersibility allows for easy cleaning of the nozzles of the printer and prevents clogging during printing or in the idle state.

Preferably, 50 to 100 mol % of the acid groups from (d) are neutralized. This brings about a monomodal particle size distribution of the dispersed particles and increases the stability of the dispersion.

The optional component (f) is at least one nucleophilic alcohol or amine, preferably monoalcohol or monoamine, which may serve as a stopper for any free isocyanate groups still present in the urethane (meth)acrylate. Preferred stoppers (f) are diethylamine, di-n-butylamine, ethanolamine, propanolamine, N, N-dipropanolamine and N,N-diethanolamine. Mono- and dialkylamines having longer alkyl groups than C₁-C₄-alkyl groups are excluded from the invention, since these lower the hydrophilicity of the urethane (meth)acrylates. Likewise ruled out are diamines and polyfunctional amines, since these act as chain extenders and increase the molecular weight of the urethane (meth)acrylate, which makes dispersibility or solubility more difficult.

It is possible to use up to 10% by weight of stopper (f), based on polyurethane (meth)acrylate to be synthesized. The function of the compounds (f) is to satisfy any unconverted isocyanate groups remaining in the course of preparation of the polyurethane (meth)acrylate polymer.

The obligatory compound (g) is at least one monofunctional polyalkylene oxide polyether alcohol, obtainable by alkoxylation of alcohols. Very particular preference is given to those based on polyalkylene oxide polyether alcohols prepared using saturated aliphatic alcohols having 1 to 4 carbon atoms in the alkyl radical. Especially preferred polyalkylene oxide polyether alcohols are those prepared starting from methanol. The monohydric polyalkylene oxide polyether alcohols contain an average of generally up to 90 alkylene oxide units, preferably ethylene oxide units, per molecule, in copolymerized form, preferably up to 45, more preferably up to 40 and most preferably up to 30.

The composition of particular preferred polyurethane (meth)acrylate polymers is as follows:
(a) 100 mol % of isocyanate functions in the sum total of (a1) and (a2),
(b) 5 to 35 mol %, preferably 15 to 35 mol %, of hydroxyl functions in the sum total of (b1) and (b2) (based on isocyanate functions in (a)),
(c) 20 to 80 mol %, preferably 30 to 70 mol %, of hydroxyl functions (based on isocyanate functions in (a)),
(d) 20 to 60 mol %, preferably 25 to 50 mol %, of hydroxyl functions (based on isocyanate functions in (a)),
(e) 60 to 100 mol %, preferably 80 to 100 mol %, of base (based on acid functions in (d)),
(f) 0 to 30 mol %, preferably 5 to 30 mol %, more preferably 10 to 25 mol %, of hydroxyl or amino functions which react with isocyanate (based on isocyanate functions in (a)),
(g) 0.5 to 10 mol %, preferably 1 to 5 mol %, of hydroxyl functions (based on isocyanate functions in (a)),
with the proviso that the sum total of the isocyanate-reactive groups in components (b), (c), (d), and (g) is 70 to 100 mol % of isocyanate-reactive groups, preferably 75 to 100 mol % and more preferably 80 to 100 mol % (based on isocyanate functions in (a)).

The reaction is of components (b), (c), (d), and (g) can preferably be stopped by addition of component (f) at a conversion of isocyanate groups of 60 to 100%, more preferably at 70 to 100% and most preferably at 75 to 100%.

When the isocyanate groups of component (a) are in the form of two different components (a1) and (a2), the ratio of (a1) to (a2) (based on the amount of the isocyanate groups present therein) is from 4:1 to 1:4, preferably from 2:1 to 1:4, more preferably from 1:1 to 1:4 and most preferably from 1:3 to 1:4. Otherwise, the figures for the sum total of components (a1) and (a2) are of course based only on the one component (a).

The molecular weight M_{w} of the polyurethane (meth)acrylate polymer may, for example, be 1,000 to a maximum of 50,000 g/mol, preferably 3,000 to 30,000 g/mol, more preferably 5,000 to 25,000 g/mol and most preferably at least 5,000 g/mol, determined, for example, by means of gel permeation chromatography (GPC) using polystyrene as internal standard.

In order to achieve a high degree of crosslinking during curing of the aqueous ink composition (AC), it is preferred if the polyurethane (meth)acrylate polymer contains 1 to 5 mol, preferably 2 to 4 mol, of (meth)acryloyl groups per 1,000 g of polyurethane (meth)acrylate.

The polyurethane (meth)acrylate polymer preferably has a glass transition temperature of not more than 50° C., preferably not more than 40° C., determined according to ASTM 3418/82(1988) at a heating rate of 10° C./min.

In a preferred embodiment, the polyurethane (meth)acrylate polymer does not comprise any free NCO groups.

The polyurethane (meth)acrylate polymer can be prepared from components (a) to (g) by initially charging at least components (b) and (c) and optionally (d) at least in part, preferably in full, and adding the isocyanate (a) to this mixture of the initially charged components. The reaction mixture is then reacted at temperatures of 25 to 100° C., preferably 40 to 90° C., over a period of 3 to 20 hours, preferably of 4 to 12 hours, with stirring or pumped circulation. In general, component (f) is added when the components present in the reaction mixture have essentially reacted, for example have reacted to an extent of at least 50%, preferably to an extent of at least 75%. The reaction is accelerated by addition of a suitable catalyst known in literature. If unconverted isocyanate groups should still be present, the reaction can be completed under the above reaction conditions by reaction with the stopper (f). After the preparation, the reaction mixture is dispersed or diluted in water.

The dispersion (i) of the polyurethane (meth)acrylate polymer usually has a solids content of 35 to 45%, but the latter may also be up to 60%.

The mean particle size in the dispersion (i) is generally 10 to 150 nm, preferably 15 to 120 nm, more preferably 20 to 100 nm, most preferably 20 to 90 nm.

The ink composition (AC) preferably comprises the at least one aqueous dispersion of the polyurethane (meth)acrylate polymer (i) in a total amount of 15 to 95 parts, preferably 20 to 50 parts, very preferably 25 to 35 parts, based on 100 parts of the ink composition. Use of the stated amounts in the ink composition result in a high double bond conversion of at least 70%, more preferably at least 75%, more preferably still at least 80%, very preferably at least 85%, more particularly at least 90% and thus in a highly crosslinked ink layer having a high adhesion to the substrate (S) as well as high stability against environmental influences. Moreover, the high double bond conversion leads to non-toxic cured ink compositions suitable for substrates (S) which are in direct contact with skin.

### Pigment and/or Dye (ii)

Pigments are virtually water-insoluble, finely divided organic or inorganic colorants as defined in DIN 55944. The terms “coloring pigment” and “color pigment” are interchangeable. In contrast, the term “dye” denotes colorants which are soluble in the primary solvent and/or co-solvent present in the ink composition (AC).

Ink compositions (AC) preferably used in the inventive method comprise at least one pigment (ii) selected from the group consisting of inorganic pigments, such as titanium dioxide, zinc white, zinc sulfide, lithopone, carbon black, iron manganese black, spinel black, chromium oxide, chromium oxide hydrate green, cobalt green, ultramarine green, cobalt blue, ultramarine blue, manganese blue, ultramarine violet, cobalt violet and manganese violet, red iron oxide, cadmium sulfoselenide, molybdate red, and ultramarine red, brown iron oxide, mixed brown, spinel phases and corundum phases, and chromium orange, yellow iron oxide, nickel titanium yellow, chromium titanium yellow, cadmium sulfide, cadmium zinc sulfide, chromium yellow, and bismuth vanadate; organic pigments, such as monoazo pigments, disazo pigments, anthraquinone pigments, benzimidazole pigments, quinacridone pigments, quinopthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments and/or aniline black; and mixtures thereof.

Useful effect pigments are, for example, platelet-shaped metal effect pigments such as lamellar aluminum pigments, gold bronzes, oxidized bronzes and/or iron oxide-aluminum pigments, pearlescent pigments such as pearl essence, basic lead carbonate, bismuth oxide chloride and/or metal oxide-mica pigments and/or other effect pigments such as platelet-shaped graphite, platelet-shaped iron oxide, multilayer effect pigments composed of PVD films and/or liquid crystal polymer pigments. Particularly preferred are platelet-shaped metal effect pigments, more particularly plated-shaped aluminum pigments.

In order to prevent clogging of parts of the used printer, it is desirable to use pigments with particles sizes D₉₀ of less than 1 μm.

Dyes which can be advantageously employed in the present invention are water-soluble direct dyes and/or water-soluble acid dyes and/or cationic dyes. Suitable direct dyes are, for example, C.I. Direct Yellow 1, 8, 11, 12, 24, 26, 27, 33, 39, 44, 50, 58, 85, 86, 88, 98, 100, 110, C.I. Direct Red 1, 2, 4, 9, 11, 13, 17, 20, 23, 24, 28, 31, 33, 37, 39, 44, 62, 81, 83, 99, 227, C.I. Direct Blue 1, 2, 6, 8, 15, 22, 25, 71, 76, 78, 86, 98, 108, 120, 192, 193, 194, 195, 196, 199, 200, 201, 202, 203, 207, 236, 237, C.I. Direct Black 2, 4, 17, 19, 22, 32, 38, 51, 56, 62, 71, 74, 75, 77, 105, 108, 112, 154 and mixtures thereof. Suitable acid dyes are, for example, C.I. Acid Yellow 7, 17, 23, 29, 42, 99, C.I. Acid Orange 56, 64, C.I. Red 18, 87, 92, 94, C.I. Acid Blue 1, 7, 9, 234, 236, C.I. Acid Green 12, 19, 27, 41, C.I. Acid Black 1, 2, 7, 24, 94 and mixtures thereof. Useful types of cationic dyes include azo compounds, diphenylmethane compounds, triarylmethanes, xanthene compounds, acridine compounds, quinoline compounds, methine or polymethine compounds, thiazole compounds, indamine or indophenol compounds, azine compounds, oxazine compounds, thiazine compounds and mixtures thereof.

The total amount of the at least one pigment and/or dye (ii) is preferably in the range from 0.01 to 5 parts, more preferably 0.1 to 2.5 parts, very preferably 0.2 to 0.5 parts, based on 100 parts of the ink composition. The stated amounts do not interfere with the crosslinking of the polymer (i) during curing, allow a high degree of coverage of the substrate (S) and result in images with brilliant colors.

### Photoinitiator (iii)

For curing with the aid of UV light, the ink composition (AC) used in step (3) preferably comprises at least one photoinitiator as component (iii). In the case of curing with electron beams or (N)IR, on the other hand, the presence of such photoinitiators is not necessary. The ink composition (AC) preferably comprises as component (iii) at least one photoinitiator which can be decomposed by light of the irradiated wavelength to give radicals which in turn are able to initiate a radical polymerization.

Photoinitiators such as UV photoinitiators are known to the skilled person. Those contemplated include, for example, phosphine oxides, benzophenones, thioxanthones, anthraquinones, acetophenones such as α-aminoaryl ketones and/or α-hydroxyalkyl aryl ketones, benzoins and benzoin ethers, ketals, imidazoles or phenylglyoxylic acids, and mixtures thereof.

The at least one photoinitiator (iii) is preferably selected from the group consisting of phosphine oxides, benzophenones, thioxanthones, anthraquinones, acetophenones such as α-aminoaryl ketones and/or α-hydroxyalkyl aryl ketones, benzoins and benzoin ethers, ketals, imidazoles or phenylglyoxylic acids, and mixtures thereof.

Phosphine oxides are, for example, monoacyl- or bisacylphosphine oxides, examples being 2,4,6-trimethylbenzoyldiphenylphosphine oxide, ethyl 2,4,6-trimethylbenzoylphenylphosphinate or bis(2,6-dimethoxy-benzoyl)-2,4,4-trimethylpentylphosphine oxide. Examples of benzophenones are benzophenone, 4-aminobenzophenone, 4,4′-bis(dimethylamino)benzophenone, 4-phenylbenzophenone, 4-chlorobenzophenone, Michler's ketone, o-methoxybenzophenone, 2,4,6-trimethylbenzophenone, 4-methylbenzophenone, 2,4-dimethylbenzophenone, 4-isopropylbenzophenone, 2-chlorobenzophenone, 2,2′-dichlorobenzophenone, 4-methoxybenzophenone, 4-propoxybenzophenone or 4-butoxybenzophenone; α-hydroxyalkyl aryl ketones are, for example, 1-benzoyl-cyclohexan-1-ol (1-hydroxycyclohexyl phenyl ketone), 2-hydroxy-2,2-dimethylaceto-phenone (2-hydroxy-2-methyl-1-phenylpropan-1-one), 1-hydroxyacetophenone, 1-[4-(2-hydroxyethoxy)phenyl]-2-hydroxy-2-methylpropan-1-one, or polymer comprising in copolymerized form 2-hydroxy-2-methyl-1-(4-isopropen-2-ylphenyl)propan-1-one. Xanthones and thioxanthones are, for example, 10-thioxanthenone, thioxanthen-9-one, xanthen-9-one, 2,4-dimethylthioxanthone, 2,4-diethylthioxanthone, 2,4-diisopropylthioxanthone, 2,4-dichlorothioxanthone or chloroxanthenone; anthraquinones are, for example, β-methylanthraquinone, tert-butylanthraquinone, anthraquinonecarboxylic esters, benzo[de]anthracen-7-one, benzo[a]anthracene-7,12-dione, 2-methylanthraquinone, 2-ethylanthraquinone, 2-tert-butylanthraquinone, 1-chloroanthraquinone or 2-amylanthraquinone. Acetophenones are, for example, acetophenone, acetonaphthoquinone, valerophenone, hexanophenone, α-phenylbutyrophenone, p-morpholinopropio-phenone, dibenzosuberone, 4-morpholinobenzophenone, p-diacetylbenzene, 4′-methoxyacetophenone, α-tetralone, 9-acetylphenanthrene, 2-acetylphenanthrene, 3-acetylphenanthrene, 3-acetylindole, 9-fluorenone, 1-indanone, 1,3,4-triacetylbenzene, 1-acetonaphthone, 2-acetonaphthone, 2,2-dimethoxy-2-phenylacetophenone, 2,2-diethoxy-2-phenylacetophenone, 1,1-dichloroaceto-phenone, 1-hydroxyacetophenone, 2,2-diethoxyacetophenone, 2-methyl-1-[4-(methylthio)phenyl]-2-morpholinopropan-1-one, 2,2-dimethoxy-1,2-diphenylethan-2-one or 2-benzyl-2-dimethylamino-1-(4-morpholinophenyl)butan-1-one. Benzoins and benzoin ethers are, for example, 4-morpholinodeoxybenzoin, benzoin, benzoin isobutyl ether, benzoin tetrahydropyranyl ether, benzoin methyl ether, benzoin ethyl ether, benzoin butyl ether, benzoin isopropyl ether or 7H-benzoin methyl ether. Ketals are, for example, acetophenone dimethyl ketal, 2,2-diethoxyacetophenone, or benzil ketals, such as benzil dimethyl ketal. Typical mixtures comprise, for example, 2-hydroxy-2-methyl-1-phenylpropan-2-one and 1-hydroxycyclohexyl phenyl ketone, bis(2,6-dimethoxybenzoyl)-2,4,4-trimethylpentylphosphine oxide and 2-hydroxy-2-methyl-1-phenylpropan-1-one, benzophenone and 1-hydroxycyclohexyl phenyl ketone, bis(2,6-dimethoxybenzoyl)-2,4,4-trimethylpentylphosphine oxide and 1-hydroxycyclohexyl phenyl ketone, 2,4,6-trimethylbenzoyldiphenylphosphine oxide and 2-hydroxy-2-methyl-1-phenylpropan-1-one, 2,4,6-trimethylbenzophenone and 4-methylbenzophenone, or 2,4,6-trimethylbenzophenone and 4-methylbenzophenone and 2,4,6-trimethylbenzoyldiphenylphosphine oxide.

Preferred among these photoinitiators are 2,4,6-trimethylbenzoyldiphenylphosphine oxide, ethyl 2,4,6-trimethylbenzoylphenylphosphinate, bis(2,4,6-trimethyl-benzoyl)phenylphosphine oxide, benzophenone, 1-benzoylcyclohexan-1-ol, 2-hydroxy-2,2-dimethylacetophenone, and 2,2-dimethoxy-2-phenylacetophenone, especially preferred is a mixture of bis-acetylphospine oxide and monoacylphosphine oxide. Preferably, therefore, at least one such photoinitiator is used as component (iii).

The total amount of the at least one photoinitiator (iii) is preferably in the range from 0.01 to 8 parts, more preferably 0.1 to 7 parts, even more preferably 0.2 to 5 parts, very preferably 0.2 to 1.5 parts, based on 100 parts of the ink composition. The use of the photoinitiator (iii) in the state amounts results in an effective curing of the ink composition (AC) when using UV light and therefore yields cured ink layers (IL) having a high adhesion to the substrate and a high stability of the printed and cured images against environmental influences.

### Surfactant (iv)

The ink composition (AC) can further comprise at least one surfactant (iv).

Surfactants are compounds that lower the surface tension (or interfacial tension) between two liquids, between a gas and a liquid, or between a liquid and a solid. Surfactants are usually organic compounds that are amphiphilic, meaning they contain both hydrophobic groups (their tails) and hydrophilic groups (their heads). Therefore, a surfactant contains both a water-insoluble (or oil-soluble) component and a water-soluble component. Surfactants will diffuse in water and adsorb at interfaces between air and water or at the interface between oil and water, in the case where water is mixed with oil. The water-insoluble hydrophobic group may extend out of the bulk water phase, into the air or into the oil phase, while the water-soluble head group remains in the water phase.

Surfactants used in ink jet inks are classified into high HLB (typically HLB of more than 13) surfactants and low HLB surfactants (typically HLB of less than 13). As used herein, the term “hydrophilic and lipophilic balance” or “HLB” means a value determined in accordance with the method described in P. Becher et al., “Nonionic Surfactant, Physical Chemistry,” Marcel Dekker, New York (1987), pages 439-456. The HLB value is an empirical value on an arbitrary scale that is conveniently and widely used in surfactant chemistry to provide a measure of the polarity of a surfactant or mixture of surfactants.

While high HLB surfactants are typically used to support the colloidal stability of the ink, low HLB surfactants are used to lower the surface tension, so that the ink can wet the nozzle capillary to establish and maintain the meniscus at the nozzle tip. The importance of maintaining the meniscus at the nozzle tip both in the steady state and in the dynamic state is critical for start-up, reducing latency (defined as number of firings needed before the ink establishes the first stable drop of jetting), increased elapsed time between jetting without refreshing and ultimately long-term reliable continuous printing. For some print heads, reliable jetting or printing can only be achieved if the nozzle plate is wetted. This low HLB surfactant is also a major factor which determines the interaction between the ink and the substrate and therefore controls or affects wetting, bleeding, dot-gain, dot-quality and ultimately the image quality. Surfactants affect these properties through a physical parameter, namely surface tension (both static and dynamic). The surface tension is preferably in the range from 10 to 70 mN/m, more preferably 15 to 60 mN/m, very preferably 20 to 50 mN/m, measured according to DIN EN 14210:2004-03 (ring method) at 23° C.

The at least one surfactant (iv) preferably has a HLB value in the range from 1 to 6, very preferably 2 to 5. The aforementioned values are referring to the HLB value of a single surfactant. Thus, if a mixture of surfactants is used, the stated HLB value is not the HLB value of the mixture of surfactants but the HLB value of at least one surfactant comprised in the surfactant mixture.

Preferably, the at least one surfactant (iv) is selected from the group consisting of nonionic surfactants, anionic surfactants, cationic surfactants, fluorinated surfactants, silicone surfactants and mixtures thereof, preferably non-ionic acetylenic surfactants and/or silicon surfactants. Nonionic surfactants do not comprise any anionic or cationic groups or groups, which can form cations or anions at specific pH values. In contrast, anionic surfactants contain at least one anionic group, for example a carboxylate, sulfate, sulfonate or phosphate group. Cationic surfactants contain at least on cationic group, preferably a quaternized amine group. Fluorinated surfactants possess at least one fluoro atom while silicone surfactants have at least one SiO₂-group in the molecule.

The nonionic surfactant is preferably selected form the group consisting of acetylenic surfactants such as 3,6-dimethyl-4-octyne-3,6-diol, 2,4,7,9-tetramethyl-5-decin-4,7-diol and ethoxylated acetylenic surfactants; reaction products of poly(oxyalkylene glycol) with C₈-C₃₀ carboxylic acids, C₈-C₃₀ alcohols, C₈-C₃₀ amines, sorbitan esters, alkanol amides, castor oil; C₈-C₃₀ amines and derivates thereof; nonionic polymers such as poly(propylene oxide)/poly(ethylene oxide) copolymers, poly(alkylene glycol), polyvinyl alcohol, polyacrylic acid, hydrophobically-substituted polyacryl amide, methyl cellulose, ethyl cellulose, hydroxy ethyl cellulose, carboxy methyl cellulose, polyoxyethylene alkyl ethers, polyoxyethylene nonylphenyl ether, alkyl or dialkyl phenoxy poly(ethyleneoxy)ethanol derivatives defoaming silicon compounds, blends of organic esters in mineral oil base, EO/PO block copolymers; and mixtures thereof, preferably 2,4,7,9-tetramethyl-5-decin-4,7-diol. Especially suitable nonionic surfactants are relatively short-chain ethylene glycol nonionic surfactants such as the Air Products Surfynol™ line, especially Surfynol™ 465. Acetylenediol- and ethoxylated acetylenediol-based surfactants are especially suitable because they improve the wetting properties of the ink and enable suppression of coalescence of the ink droplets in the initial period immediately following ink impact. Due to the improved wet spreading that yields an increase in surface area, the drying process is also improved.

The anionic surfactant is preferably selected form the group consisting of sulphonated fatty esters, phosphated fatty esters, alkyl sulphoxides and alkyl sulphones, sodium alkyl sulphates, sodium dodecylbenzene sulphonate, sodium dodecyl naphthalene sulphate, sodium dodecyl diphenyloxide disulphonate, sodium alkyl sulphosuccinates, potassium N-methyl-N-oleoyl taurate, carboxymethylamylose and mixtures thereof. Anionic surfactants such as Aerosol™ OT are also used.

The cationic surfactant is advantageously selected form the group consisting of dialkyl benzenealkyl ammonium chloride, alkylbenzyl methyl ammonium chloride, cetyl pyridinium bromide, alkyl trimethyl ammonium bromides, halide salts of quaternized polyoxyethylalkylamines, dodecylbenzyl triethyl ammonium chloride, quaternary alkosulphate compounds, fatty imidazolines and mixtures thereof.

Silicone surfactants are built around a polydimethylsiloxane backbone to which different hydrophilic groups, such as polyoxyethylene glycol, can be attached. Siloxane surfactants are characterized by high chemical and thermal stability, effectively reduce the surface tension and can simultaneously act as defoamers. At the same time, because of a high adsorption affinity of siloxane surfactants to hydrophobic surfaces, the surface tension of the solid/liquid may even become negative, thus yielding a positive value for the spreading coefficient. Suitable silicon surfactants are represented by the general formula (II) or (III) shown below.

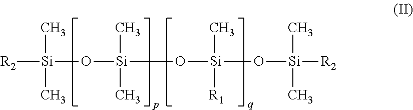

In general formula (II), p represents an integer of 0 or greater and q represents an integer of 1 or greater. Furthermore, residue R₂ represents a C₁-C₆ alkyl group. Residue R₁ represents a group of general formula (IIa) below, wherein the *-symbol represents the connection of general formula (IIa) to the silicon atom. *—(CH₂)ₘ—(OC₂H₄)ₙ—(OC₃H₆)ₒ—R₃ (IIa)

In general formula (IIa), m represents an integer of 1 to 6, n represents an integer of 0 to 50 and o represents an integer of 0 to 50, with the proviso that n+o is at least 1. R₃ represents a hydrogen atom, a C₁-C₆ alkyl group or a (meth)acrylic group.

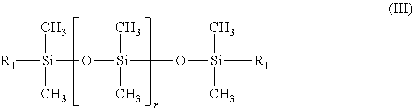

In general formula (III), r represents an integer of 1 to 80 and R₁ is a group of general formula (IIa) described above.

Commercial examples of the silicon surfactants represented by formula (II) are manufactured by Dow Corning Toray as products SF8428, FZ-2162, 8032 ADDITIVE, SH3749, FZ-77, L-7001, L-7002, FZ-2104, FZ-2110, F-2123, SH8400, and SH3773M, by BYK Chemie as products BYK-345, BYK-346, BYK-347, BYK-348, and BYK-349, by Evonik Degussa as products Tegowet250, Tegowet260, Tegowet270, and Tegowet280, by Shin-Etsu Chemical Co., Ltd. as products KF-351A, KF-352A, KF-353, KF-354L, KF355A, KF-615A, KF-640, KF-642, KF-643 and by Nissin Chemical Industry Co., Ltd. as SAG series. Examples of commercially available products of the compound represented by the above general formula (III) are manufactured by Dow Corning Toray Co., Ltd. as products BY16-201 and SF8427, by BYK Chemie as products BYK-331, BYK-333, BYK-UV3500 and by Evonik Degussa as products Tegoglide410, Tegoglide432, Tegoglide435, Tegoglide440, Tegoglide450.

Preferred silicon surfactants have a HLB value of 2 to 5.

These silicon surfactants are generally slower to orient at the liquid surface as the preferred non-ionic acetylenediol-based surfactants. Moreover, the silicon surfactant can also help to increase the water repellency and abrasion resistance of the printed substrate (S).

Preferred ink compositions (AC) comprise at least one surfactant (iv) containing at least one non-ionic acetylenediol-based surfactant (iv-1), preferably 2,4,7,9-tetramethyl-5-decin-4,7-diol, and at least one silicon surfactant (vi-2), preferably a polyether modified siloxane. Particularly preferred polyether modified siloxanes are represented by the general formula (II) described above.

In this regard, it is preferred if the at least one non-ionic acetylenediol-based surfactant (iv-1), preferably 2,4,7,9-tetramethyl-5-decin-4,7-diol, and at least one silicon surfactant (vi-2), preferably a polyether modified siloxane of general formula (I) are present in a weight ratio of 2:1 to 1:2, very preferably 1:1.6.

Examples of fluorinated surfactants suitable for use in the ink composition (AC) are F(CF₂CF₂)₃₋₈CH₂CH₂SCH₂CH₂COOLi, F(CF₂CF₂)₃₋₈CH₂CH₂PO₄(NH₄)₂, F(CF₂CF₂)₃₋₈CH₂CH₂(OCH₂CH₂)₁₋₁₀OH, anionic bitail fluorothioalkyl surfactants (for example (C₁₀F₂₁—CH₂—S)₂C(CH₃)CH₂CH₂COOLi) and mixtures thereof. Because of exceptional chemical stability of fluorocarbon residues, fluorinated surfactants are resistant to extreme temperature conditions and aggressive environment. Unlike many traditional surfactants, fluorinated surfactants preserve their surface-active properties in non-aqueous solutions. At the same time, they behave as dewetting agents for high-energy surfaces. Since fluorinated surfactants are expensive, have a poor biodegradability and might lead to undesired residues on printed substrates designed for skin contact, preferred ink compositions (AC) do not comprise any fluorinated surfactants, i.e. their amount is 0% by weight, based on the total weight of the ink composition (AC).

In preferred embodiments of the ink composition (AC), at least one nonionic and/or silicon surfactant is used to modify the surface tension of the ink composition. Thus, the ink composition (AC) advantageously comprises the at least one surfactant (iv), preferably the at least one nonionic and/or the at least one silicon surfactant, very preferably 2,4,7,9-tetramethyl-5-decin-4,7-diol and/or polyether modified siloxane, in a total amount of 0.01 to 1 parts, preferably 0.02 to 0.5 parts, very preferably 0.02 to 0.2 parts, based on 100 parts of the ink composition. Use of the at least one nonionic surfactant, especially 2,4,7,9-tetramethyl-5-decin-4,7-diol, and/or at least one silicone surfactant, especially a polyether modified siloxane of general formula (I), in the stated amounts leads to a surface tension which is neither too high nor too low, thus resulting in printed images having a high resolution.

### Additive (v)

Furthermore, the ink composition (AC) used in the inventive process may comprise at least one additive (v). The additive (v) is preferably selected from the group consisting of flow control agents, thickeners, thixotropic agents, plasticizers, lubricity additives, antiblocking additives and mixtures thereof. Very preferably, the ink composition (AC) further comprises at least one additive (v), selected from the group consisting of rheology modifiers (v-1), humectants (v-2), co-solvents (v-3), biocides (v-4) and mixtures thereof.

Rheology modifiers (v-1) are organic or inorganic additives that control the rheological characteristics of the ink and enable damping control and droplet formation. These can be divided into inorganic and organic materials; inorganic additives are typically clays, and fumed silicas, whereas organic materials can be subdivided into natural materials such as cellulosics/xanthan gum and synthetic materials which are associative or non-associative type materials.

Inorganic rheology modifiers are typically dispersed into a coating and function as suspended or gelling agents. Usually the viscosity of the formulation decreases with time and the constant shear conditions as its gel structure is broken down. If this shear is removed, the coating gradually recovers to its original viscosity. Inorganic rheology modifiers are sometimes added to aqueous formulations as secondary thickeners to improve the anti-sag, anti-settling, anti-syneresis and anti-spattering properties of the ink. Suitable inorganic rheology modifiers are, for example, synthetic hectorite clays which are commercially available, for example, from Southern Clay Products, Inc., and include Laponite®; Lucenite SWN®, Laponite S®, Laponite XL®, Laponite RD® and Laponite RDS®.

Organic rheology modifiers are more diverse in nature and subdivide into many structural types. Non-associative rheology modifiers act by entanglement of soluble, high molecular weight polymer chains and thus their effectiveness is mainly controlled by the molecular weight. These tend to have pseudoplastic rheology, giving good stabilization against settling and sagging. Associative thickeners function by non-specific interactions of hydrophobic end groups with both themselves and components of the ink forming a physical network. Suitable organic rheology modifiers include non-associative rheology modifiers, and non-ionic associative type rheology modifiers, also known as a non-ionic associative thickeners. Examples of non-associative rheology modifiers include, but are not limited to, alkali swellable emulsions (ASE), such as acrylic emulsions. Suitable associative rheology modifiers include, but are not limited to, hydrophobically modified alkali swellable emulsions (HASE), such as hydrophobically modified acrylic emulsions, hydrophobically modified polyurethanes (HEUR); hydrophobically modified polyethers (HMPE); or hydrophobic ethoxylated aminoplast technology (HEAT). Further suitable organic thickeners include glycerine and fatty acid modified polyesters.

The ink composition (AC) preferably comprises the at least one rheology modifier (v-1) in a total amount of 0.01 to 1 parts, based on 100 parts of the ink composition.

Humectants (v-2) are hydroscopic organic compounds which are capable of binding water vapor from the air under given humidity and temperature conditions so that drying of the ink is slowed down or completely stopped. This is very important to prevent the ink from drying on the nozzle and from clogging the nozzle both during the printing and in the idling state.

Examples of humectants (v-2) which can be used include polyhydric alcohols, such as glycerin, ethylene glycol, diethylene glycol, triethylene glycol, tetraethylene glycol, propylene glycol, dipropylene glycol, tripropylene glycol, 1,3-butane diol, 2,3-butane diol, 1,4-butane diol, 3-methyl-1,3-butane diol, 1,5-pentane diol, tetraethylene glycol, 1,6-hexane diol, 2-methyl-2,4-pentane diol, polyethylene glycol, 1,2,4-butanetriol, 1,2,6-hexanetriol and thioglycol; sugars such as glucose, mannose, fructose, ribose, xylose, arabinose, galactose, aldonic acid, glucitol, maltose, cellobiose, lactose, sucrose, trehalose, maltotriose; sugar alcohols, such as sorbitol and sorbitan; hyaluronic acids; lower alkyl mono- or di-ethers derived from alkylene glycols, such as ethylene glycolmonobutyl ether, diethylene glycolmonomethyl ether, diethylene glycolmonoethyl ether, diethylene glycolmono-n-propyl ether, ethylene glycolmono-iso-propyl ether, diethylene glycolmono-iso-propyl ether, ethylene glycolmono-n-butyl ether, ethylene glycolmono-t-butyl ether, diethylene glycolmono-t-butyl ether, propylene glycolmonomethyl ether, propylene glycolmonoethyl ether, propylene glycolmono-t-butyl ether, propylene glycolmono-n-propyl ether, propylene glycolmono-iso-propyl ether, dipropylene glycolmonomethyl ether, dipropylene glycolmonoethyl ether, dipropylene glycolmono-n-propyl ether, dipropylene glycolmono-iso-propyl ether; lactones such as γ-butyrolactone; acetin, diacetin and triacetin; nitrogen-containing cyclic compounds, such as pyrrolidone, N-methyl-2-pyrrolidone, urea, bis-hydroxyethyl-5,5-dimethylhydantoin, lactic acid monoethanolamide and 1,3-dimethyl-2-imidazolidinone; sulfur-containing compounds, such as dimethyl sulfoxide and tetramethylene sulfone; and mixtures thereof.

Some of the beforementioned humectants (v-2) can also function as co-solvents (v-3), for example 2-pyrrolidone. In this case, the humectant will simultaneously function as co-solvent and addition of further co-solvents might not be necessary. However, it is also possible to add at least one further co-solvent (v-3) to prevent clogging of the nozzle.

The ink composition (AC) preferably comprises the at least one humectant (v-2) in a total amount of 0.01 to 30 parts, based on 100 parts of the ink composition.

A co-solvent is a substance which is added to the primary solvent in small amounts in order to increase the solubility of compounds present in the ink. This allows to use compounds in the ink composition, which are not fully soluble in the primary solvent and would therefore block the nozzles of the printer.

Preferred co-solvents (v-3) are organic compounds which are fully or at least partially miscible with the primary solvent, preferably water, at a temperature of 20 to 60° C. Suitable co-solvents (v-3) are, for example, (1) alcohols, such as methyl alcohol, ethyl alcohol, n-propyl alcohol, iso-propyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols such as acetone, methyl ethyl ketone, methyl isobutyl ketone and diacetone alcohol; (3) ethers, such as tetrahydrofuran and dioxane; (4) esters, such as ethyl acetate, butyl acetate, ethyl lactate, ethylene carbonate and propylene carbonate; (5) polyhydric alcohols, such as ethylene glycol, diethylene glycol, triethylene glycol, propylene glycol, tetraethylene glycol, polyethylene glycol, glycerol, 2-methyl-2,4-pentanediol 1,2,6-hexanetriol and thiodiglycol; (6) lower alkyl mono- or di-ethers derived from alkylene glycols, such as ethylene glycol mono-methyl (or -ethyl) ether, diethylene glycol mono-methyl (or -ethyl) ether, propylene glycol mono-methyl (or -ethyl) ether, triethylene glycol mono-methyl (or -ethyl) ether and diethylene glycol di-methyl (or -ethyl) ether; (7) nitrogen containing cyclic compounds, such as pyrrolidone, N-methyl-2-pyrrolidone, and 1,3-dimethyl-2-imidazolidinone; (8) sulfur-containing compounds such as dimethyl sulfoxide and tetramethylene sulfone and mixtures thereof.

Some of the beforementioned co-solvents (v-3) can also function as humectant (v-2), for example 2-pyrrolidone. In this case, the co-solvent will simultaneously function as humectant and addition of further humectants might not be necessary. However, it is also possible to add at least one further humectant (v-2) to prevent clogging of the nozzle.

The ink composition (AC) preferably comprises the at least one co-solvent (v-3) in a total amount of 0.01 to 30 parts, based on 100 parts of the ink composition.

Any of the biocides (v-4) commonly employed in ink-jet inks may be employed in the practice of the invention, such as aqueous dipropylene glycol solutions of 1,2-benzisothiazolin-3-one available under the name PROXEL from Avecia, Ltd., Manchester, UK, methyl p-hydroxybenzoate, 6-acetoxy-2,2-dimethyl-1,3-dioxane, glutaraldehyde, semyphormal glycol, isothiazolinons and mixtures thereof.

The ink composition (AC) preferably comprises the at least one biocide (v-4) in a total amount of 0.01 to 1 parts, based on 100 parts of the ink composition.

The ink used in step (3) of the inventive method is preferably non-toxic and thus does not—or only in very small amounts—contain (meth)acrylate compounds with a number average molecular weight Mₙ of less than 1,200 g/mol. These compounds—if remaining in the ink after curing—can lead to skin irritation and/or odor nuisance and their use is therefore not preferred. Thus, highly preferred ink compositions (AC) used in step (3) comprise (meth)acrylates with a number average molecular weight Mₙ of less than 1,200 g/mol in a total amount of 0 to 2% by weight, preferably 0 to 1% by weight, very preferably 0% by weight, based on the total weight of the ink composition (AC). The amount of these (meth)acrylates can be determined for example by gel permeation chromatography calibrated against polystyrene standards.

The ink composition (AC) used in step (3) of the inventive method is preferably an aqueous ink composition. With particular preference the aqueous ink composition has, based on its total weight, a fraction of water of 5 to 95 parts, preferably 35 to 90 parts, more preferably 50 to 90 parts, very preferably 60 to 90 parts, based on 100 parts of the aqueous ink composition. The aqueous ink composition preferably comprises no organic solvents.

If a liquid ink composition, preferably an aqueous ink composition (AC), is used in step (3), it preferably has a solids content of 8 to 40 parts, preferably 20 to 40 parts, very preferably 25 to 35 parts, based on 100 parts of the aqueous ink composition.

In order to guarantee that the ink composition (AC) can be printed in step (3) of the present invention, the ink composition (AC) advantageously has a viscosity of 0.01 to 100 m Pa*s, more preferably of 2 to 30 mPa*s, more preferably of 4 to 20 mPa*s, very preferably of 2 to 15 mPa*s determined using a rotational viscosimeter at 23° C. and a shear rate of 1000 s⁻¹. The viscosity is preferably measured at the jetting temperature to ensure that the ink has the correct viscosity during the printing process.

The aqueous ink composition (AC) used in step (3) of the inventive process does not lead to a clogging of the nozzles of the ink jet printer. This is due to the use of the aqueous dispersion of the polyurethane (meth)acrylate polymer, which has a high water dispersibility even after thermal drying and thus allows for easy cleaning of the nozzles of the inkjet printer.

The ink composition (AC) is deposited onto the substrate in step (3) of the present invention. Preferably, this deposition is achieved by inkjet printing. There are two main technologies in use: continuous (CIJ) and drop-on-demand (DOD) inkjet.

In continuous inkjet technology, a high-pressure pump directs the liquid solution of ink and fast drying solvent from a reservoir through a gunbody and a microscopic nozzle, creating a continuous stream of ink drops via the Plateau-Rayleigh instability. A piezoelectric crystal creates an acoustic wave as it vibrates within the gunbody and causes the stream of liquid to break into drops at regular intervals. The ink drops are subjected to an electrostatic field created by a charging electrode as they form; the field varies according to the degree of drop deflection desired. This results in a controlled, variable electrostatic charge on each drop. Charged drops are separated by one or more uncharged “guard drops” to minimize electrostatic repulsion between neighboring drops. The charged drops pass through an electrostatic field and are directed (deflected) by electrostatic deflection plates to print on the receptor material (substrate) or allowed to continue on undeflected to a collection gutter for re-use. The more highly charged drops are deflected to a greater degree. Only a small fraction of the drops is used to print, the majority being recycled. The ink system requires active solvent regulation to counter solvent evaporation during the time of flight (time between nozzle ejection and gutter recycling), and from the venting process whereby gas that is drawn into the gutter along with the unused drops is vented from the reservoir. Viscosity is monitored and a solvent (or solvent blend) is added to counteract solvent loss.

Drop-on-demand (DOD) may be divided into low resolution DOD printers using electro valves in order to eject comparatively big drops of inks on printed substrates, or high-resolution DOD printers, ejecting very small drops of ink by means of using either a thermal DOD and piezoelectric DOD method of discharging the drop.

According to a very preferred embodiment of step (3) of the inventive method, the ink composition (AC) in step (3) is deposited by means of a digital printing device comprising a drop-on-demand (DOD) inkjet printer. Use of a DOD inkjet printer in combination with the non-woven substrate (S) renders it possible to obtain high resolution images which show excellent adhesion to the substrate (S) as well as high stability against environmental influences. Moreover, the printing does not negatively influence the properties of the substrate (S) in terms of haptic and flexibility.

In the thermal inkjet process, the print cartridges contain a series of tiny chambers, each containing a heater. To eject a drop from each chamber, a pulse of current is passed through the heating element causing a rapid vaporization of the ink in the chamber to form a bubble, which causes a large pressure increase, propelling a drop of ink onto the substrate. The ink's surface tension, as well as the condensation and thus contraction of the vapor bubble, pulls a further charge of ink into the chamber through a narrow channel attached to an ink reservoir. The inks used are usually water-based and use either pigments or dyes as the colorant. The inks used must have a volatile component to form the vapor bubble, otherwise drop ejection cannot occur.

Piezoelectric DOD printers use a piezoelectric material in an ink-filled chamber behind each nozzle instead of a heating element. When a voltage is applied, the piezoelectric material changes shape, which generates a pressure pulse in the fluid forcing a drop of ink from the nozzle. A DOD process uses software that directs the heads to apply between zero to eight drops of ink per dot. This means that a single pixel or dot can have 8 levels of ink amount. These multiple levels of ink are normally generated by multiple pulses (piezo voltage on and off) shortly after each other. This will result in the ejection of multiple droplets. These droplets will while still in the air form one single bigger droplet, which will land on the substrate

In this regard, a DOD inkjet printer having at least one printhead with at least one nozzle is used. Preferably, the drop-on-demand (DOD) inkjet printer has at least one printhead, wherein the at least one printhead has one or more nozzles whose diameter is in each case in the range from 1 to 52 μm, more preferably from 15 to 40 μm, very preferably from 30 to 40 μm. In this context, it is favorable if the printhead has 1 to 1024, preferably 50 to 500, very preferably 110 to 140 nozzles. The nozzle spacing distance of the nozzle row in the printhead is preferably from 10 pm to 200 μm, more preferably from 10 μm to 85 μm, very preferably from 10 μm to 45 μm.

Very preferably, the printhead is a piezoelectric printhead. The droplet forming means of a piezoelectric printhead controls a set of piezoelectric ceramic transducers to apply a voltage to change the shape of a piezoelectric ceramic transducer. The droplet forming means may be a squeeze mode actuator, a bend mode actuator, a push mode actuator or a shear mode actuator or another type of piezoelectric actuator. Suitable commercial piezoelectric printheads are, for example, TOSHIBA TEC™ CK1 and CK1L from TOSHIBA TEC™, XAAR™ 1002 from XAAR™, Spectra SE/SM/SL 128 AA from Fujifilm, Polaris, Sapphire, Emmerald and Starfire from Dimatix Specta, 512 and 1024 series from Konica Minolta and W series from Xerox.

A liquid channel in a piezoelectric printhead is also called a pressure chamber. Between a liquid channel and a master inlet of the piezoelectric printheads, there is a manifold connected to store the liquid to supply to the set of liquid channels.

The piezoelectric printhead is preferably a through-flow piezoelectric printhead. In a preferred embodiment the recirculation of the liquid in a through-flow piezoelectric printhead flows between a set of liquid channels and the inlet of the nozzle wherein the set of liquid channels corresponds to the nozzle.

In a preferred embodiment, the printhead discharges the ink composition (AC) in a single drop size from 1 to 200 pl, in a more preferred embodiment the minimum drop size is from 15 to 100 pl, in a most preferred embodiment the minimum drop size is from 25 to 35 pl.

The angle of the printhead is preferably in the range from 0° to 90°, more preferably 0 to 45°, very preferably 0°.

In a preferred embodiment the printhead has a drop velocity from 3 meters per second to 15 meters per second, in a more preferred embodiment the drop velocity is from 5 meters per second to 10 meters per second, in a most preferred embodiment the drop velocity is from 6 meters per second to 8 meters per second.

The printing speed of the DOD printer is favorably 50 to 500 mm/s, preferably 100 to 300 mm/s, very preferably 150 to 250 mm/s.

In a preferred embodiment the printhead has a native print resolution from 25 DPI to 3,600 DPI, in a more preferred embodiment the printhead has a native print resolution from 50 DPI to 2,400 DPI and in a most preferred embodiment the printhead has a native print resolution from 150 DPI to 2,400 DPI.

The throwing distance, i.e. the distance between the at least one nozzle of the printhead and the substrate (S), can be up to 5 mm, thus also allowing to print on already shaped substrates. Preferably, the distance between the part to be printed of the at least one surface of the non-woven textile substrate (S) and the at least one nozzle of the at least one printhead in step (3) is 0.1 mm to 4 cm, preferably 0.5 to 1.5 mm.

Step (3) of the inventive method is preferably performed at a temperature of 15 to 50° C., preferably 20 to 30° C., very preferably 23° C. This temperature is also known as jetting temperature and ensures that the substrate is not damaged during the printing process.

A DOD inkjet printer suitable for step (3) of the present invention is for example a Pixdro LP50 having a Spectra SE 128 AA printhead from Fujifilm.

### Step (4)

In step (4) of the process of the invention the ink composition (AC) deposited in step (3) of the inventive process is dried and/or cured.

Drying is understood as passive or active evaporation of solvent from the applied ink composition. While the ink is no longer flowable after drying it is still soft and/or tacky. However, drying does not result in an ink layer (IL) in the service-ready state, i.e. not a cured ink layer (IL) as described later.

The curing of an ink composition is understood accordingly to be the conversion of such a composition into the service-ready state, i.e. a state in which the substrate furnished with the ink layer (IL) in question can be transported, stored, and used in its intended manner. A cured ink layer (IL) is therefore no longer soft or tacky but instead is conditioned as a solid ink layer (IL) which, even on further exposure to curing conditions as described later on, no longer exhibits any substantial change in its properties such as hardness or adhesion to the substrate.

The drying of the ink composition (AC), preferably the aqueous ink composition (AC), in step (4) preferably is performed at 30 to 100° C., very preferably 50 to 70° C., for a duration of 1 to 60 minutes, preferably 5 to 30 minutes, very preferably 5 to 20 minutes. As previously described, drying of the ink composition leads to a loss of solvent of the ink composition, thus fixing the printed image to the substrate. However, this image has not yet sufficient stability to environmental influences, which are only obtained after curing of the ink composition to form the ink layer (IL).

The curing of the ink composition (AC) in step (4) preferably is performed under nitrogen atmosphere. Said atmosphere preferably comprises an oxygen content of less than 0.1%.

According to a preferred embodiment of step (4), the ink composition (AC) deposited in step (3) is dried as stated above and then cured. The curing of the ink composition (AC) in step (4) is preferably performed by means of radiation curing, preferably by means of UV light and/or electron beam curing (EBC), very preferably by means of UV light. The corresponding apparatus used for implementing step (4) therefore preferably comprises at least one radiation source for irradiating the ink composition applied to the substrate with curative radiation.

Examples of suitable radiation sources for the radiation curing are low-pressure, medium-pressure, and high-pressure mercury emitters and also fluorescent tubes, pulsed emitters, metal halide emitters (halogen lamps), lasers, LEDs, and also electronic flash installations, enabling radiation curing without a photoinitiator, or excimer emitters. Radiation curing is accomplished by exposure to high-energy radiation, i.e., UV radiation, or by bombardment with high-energy electrons. It is of course also possible to use two or more radiation sources for the curing—two to four, for example. These sources may also each emit in different wavelength ranges.

Electron beam processing is usually effected with an electron accelerator. Individual accelerators are usefully characterized by their energy, power, and type. Low-energy accelerators provide beam energies from about 150 keV to about 2.0 MeV. Medium-energy accelerators provide beam energies from about 2.5 to about 8.0 MeV. High-energy accelerators provide beam energies greater than about 9.0 MeV. Accelerator power is a product of electron energy and beam current. Such powers range from about 5 to about 300 kW. The main types of accelerators are: electrostatic direct-current (DC), electrodynamic DC, radiofrequency (RF) linear accelerators (LINACS), magnetic-induction LINACs, and continuous-wave (CW) machines.

If curing is performed by UV radiation, the intensity used for curing in step (4) is preferably 1 to 10 W/cm², more preferably 1 to 6 W/cm². The dose is preferably 1 to 20 J/cm², more preferably 1 to 12 J/cm².

If curing is performed by electron-beam curing, the intensity used for curing in step (4) is preferably 30 to 80 kGy, more preferably 40 to 60 kGy, very preferably 50 kGy.

The statements made above, however, do not rule out that the ink composition (AC) can additionally be cured under further curing conditions, for example thermal curing conditions.

The process of the invention allows to coat non-woven textile substrates at least partially with an ink layer (IL), which has an excellent adhesion to the substrate without negatively influencing the properties, especially the haptic, of the printed substrate.

Moreover, the ink layer (IL) is highly stable against environmental influences occurring during use of the substrate and is also non-toxic, thus allowing to use the printed substrate even if it comes into contact with skin. Additionally, the method of the invention results in high resolution images and allows printing of already shaped substrates, therefore opening the possibility to personalize garments right before sale in a simple and efficient way.

### Inventive Non-Woven Textile

The result after the end of step (4) of the process of the invention is a non-woven textile substrate (S) at least partially coated with an ink layer (IL).

A second subject matter of the present invention is therefore a non-woven textile substrate (S) at least partially coated with an ink layer (IL), said substrate being produced by the inventive method.

What has been said about the method according to the invention applies mutatis mutandis with respect to further preferred embodiments of the non-woven textile substrate of the present invention.

The invention is described in particular by the following embodiments:

According to a first embodiment, the present invention relates to a method for coating a non-woven textile substrate (S) at least partially with an ink layer (IL), said method comprising:
(1) providing the non-woven textile substrate (S);
(2) optionally pretreating the non-woven textile substrate (S);
(3) depositing at least one ink composition (AC), preferably an aqueous ink composition (AC), over at least a portion of at least one surface of the non-woven textile substrate (S), the ink composition (AC) comprising:
   (i) at least an aqueous dispersion of a polyurethane (meth)acrylate polymer,
   (ii) at least one pigment and/or dye, and
   (iii) optionally at least one photoinitiator;
(4) drying and/or at least partially curing the deposited ink composition (AC) on the non-woven textile substrate (S) obtained after step (3).

According to a second embodiment, the present invention relates to a method as claimed in embodiment 1, wherein the non-woven textile substrate (S) is selected from the group consisting of thermoplastic polyurethanes, polypropylene, glass fibers and mixtures thereof, preferably thermoplastic polyurethane.

According to a third embodiment, the present invention relates to a method as claimed in embodiment 2, wherein the thermoplastic polyurethane is prepared by reacting
a) at least one polyisocyanate,
b) at least one compound having at least one isocyanate-reactive group,
c) optionally at least one chain extending compound,
d) optionally at least one chain transfer agent and
e) optionally at least one additive
f) optionally in the presence of at least one catalyst.

According to a fourth embodiment, the present invention relates to a method as claimed in embodiment 3, wherein the polyisocyanate a) is preferably selected from aliphatic, cycloaliphatic and/or aromatic polyisocyanates, more preferably aliphatic, cycloaliphatic and/or aromatic disocyanates, even more preferably aromatic diisocyanates, very preferably 4,4′-diphenylmethane diisocyanate and/or hexam ethylene diisocyanate.

According to a fifth embodiment, the present invention relates to a method as claimed in embodiments 3 or 4, wherein the least one compound having at least one isocyanate-reactive groups b) has an average functionality of 1.8 to 2.3, preferably of 1.9 to 2.2, very preferably of 2, wherein the isocyanate-reactive groups are selected from hydroxy groups, amine groups and thiol groups, preferably hydroxy groups.

According to a sixth embodiment, the present invention relates to a method as claimed in any of embodiments 3 to 5, wherein the least one compound having at least one isocyanate-reactive groups b) is selected from the group consisting of polyesteramides, polythioethers, polycarbonates, polyacetals, polyolefins, polysiloxanes, polybutadienes, polyesters polyols, polyether polyols and mixtures thereof, preferably polyether diols, polyester diols, polycarbonate diols and mixtures thereof, very preferably polyether diols and/or polyester diols.

According to an seventh embodiment, the present invention relates to a method as claimed embodiment 6, wherein the polyether diol is a linear polyether diol selected from the group consisting of polyoxytetramethylene glycols, polyether diols based on 1,2-propylene oxide, polyether diols based on ethylene oxide and mixtures thereof, wherein said polyether diols have a molecular weight M_{w} between 800 g/mol and 2,500 g/mol as determined by gel permeation chromatography.

According to an eighth embodiment, the present invention relates to a method as claimed in embodiments 6 or 7, wherein the polyester diol is selected from the group consisting of ethanediol polyadipates, 1,4-butanediol polyadipates, ethanedio1-1,4-butanediol polyadipates, 1,6-hexanediol-neopentyl glycol polyadipates, polycaprolactones and mixtures thereof, very preferably 1-4-butanediol polyadipates and/or 1,6-hexanediol-1,4-butanediol polyadipates, wherein said polyester diols have a molecular weight (weight average) of 500 to 6,000 g/mol, preferably from 600 to 3,500 g/mol, very preferably 600 to 2,000 g/mol, as determined by gel permeation chromatography.

According to a ninth embodiment, the present invention relates to a method as claimed in any of embodiments 3 to 8, wherein the at least one chain extender c) is selected from the group consisting of alkanediols having from 2 to 6 carbon atoms in the alkylene radical, more preferably 1,4-butanediol and/or dialkylene glycols having from 4 to 8 carbon atoms, very preferably 1,4-butanediol and/or 1,6-hexanediol.

According to a tenth embodiment, the present invention relates to a method as claimed in any of embodiments 3 to 9, wherein the molar ratio of the at least one compound b) to the at least one chain extender c) is in the range from 10:1 to 1:10, preferably in the range from 5:1 to 1:8, more preferably in the range from 1:1 to 1:6.4, very preferably in the range from 1:1 to 1:4.

According to a eleventh embodiment, the present invention relates to a method as claimed in any of embodiments 4 to 11, wherein the at least one chain transfer agent d) is selected from the group consisting of monofunctional alcohols and/or monofunctional amines, preferably methylamine and/or monofunctional polyols.

According to a twelfth embodiment, the present invention relates to a method as claimed in any of embodiments 3 to 11, wherein ratio of the total number of isocyanate groups of the aromatic, aliphatic and/or cycloaliphatic diisocyanate a) to the total number of active hydrogens in compound b) and chain extender c) is between 0.6 and 1.2 and more preferably between 0.8 and 1.1.

According to a thirteenth embodiment, the present invention relates to a method as claimed in any of embodiments 3 to 12, wherein the thermoplastic polyurethane is obtained by reacting:
(a) diphenylmethane 4,4′-diisocyanate (MDI) and/or hexamethylene diisocyanate,
(b) polyoxytetramethylene glycol and/or polyether diols based on 1,2-propylene oxide and ethylene oxide and/or polyester diols based on alkanediol polyadipates having from 2 to 6 carbon atoms in the alkylene radical and
(c) 1,2-ethanediol, 1,4-butanediol and/or 1,6-hexanediol,
wherein the ratio of the isocyanate groups of the component (a) to the sum of the isocyanate-reactive groups of the components (b) and (c) is preferably from 1:0.8 to 1:1.1 and (b) and (c) are used in a molar ratio of 1:1 to 1:6.4.

According to a fourteenth embodiment, the present invention relates to a method as claimed in any of embodiments 3 to 13, wherein the thermoplastic polyurethane has
a shore hardness, as determined according to DIN ISO 7619-1:2012-02 using a measuring time of 3 s, from A44 to D80, more preferably from A50 to A99, even more preferably from A60 to A95, very preferably from A70 to A90, especially preferably A80 or A83, and/or
a vicat softening temperature, as determined according to DIN EN ISO 306:2014-03 using a heating rate of 120° C./h and a load of 10N, of 40 to 160° C., more preferably of 50 to 130° C., very preferably of 80 to 120° C., and/or
a glass transition temperature T_{g}, as determined according to DIN EN ISO 11357-1:2017-02 with a heating rate of 10° C./min, of −100 to 20° C., more preferably of −80 to 20° C., even more preferably of −60 to 0° C., very preferably of −44° C., and/or
a tensile strength, as determined according to DIN 53504:2009-10 using tension bar S2, of 10 to 60 MPa, more preferably 20 to 60 MPa, even more preferably of 30 to 60 MPa, very preferably of 45 MPa or 55 MPa, and/or
an elongation at break, as determined according to DIN 53504:2009-10 using tension bar S2, of 300 to 1,300%, preferably of 400 to 1,000%, even more preferably of 500 to 800%, very preferably of 600% or 650%, and/or
a tear resistance, as determined according to DIN EN ISO 34-1:2004-07 using method B, procedure (a), of 27 to 240 kN/m, more preferably of 30 to 150 kN/m, even more preferably of 40 to 100 kN/m, very preferably of 55 kN/m or 75 kN/m, and/or
an abrasion loss, as determined according to DIN EN ISO 4649:2010-09 using Method A, of 25 to 165 mm³, more preferably of 25 to 100 mm³, even more preferably of 25 to 50 mm³, very preferably of 30 mm³ or 35 mm³.

According to a fifteenth embodiment, the present invention relates to a method as claimed in any of the preceding embodiments, wherein the non-woven textile substrate (S) has a base weight of 50 to 1,000 g/m², more preferably of 80 to 700 g/m², even more preferably of 100 to 500 g/m², very preferably of 400 to 500 g/m².

According to a sixteenth embodiment, the present invention relates to a method as claimed in any of the preceding embodiments, wherein the non-woven textile substrate (S) is pretreated by application of at least one primer composition in step (2).

According to a seventeenth embodiment, the present invention relates to a method as claimed in any of the preceding embodiments, wherein the ink composition (AC) is directly deposited on at least one surface of the non-woven textile substrate (S).

According to a eighteenth embodiment, the present invention relates to a method as claimed in any of the preceding embodiments, wherein the ink composition (AC) is deposited on at least two surfaces of the non-woven textile substrate (S).

According to an nineteenth embodiment, the present invention relates to a method as claimed in any of the preceding embodiments, wherein the polyurethane (meth)acrylate polymer is obtained by reacting:
(a) at least one (cyclo)aliphatic di- and/or polyisocyanate,
(b1) at least one (cyclo)aliphatic diol having a molar mass of less than 700 g/mol,
(b2) at least one polyester diol having a weight-average molar mass M_{w} of 700 to 2000 g/mol and preferably an acid number according to DIN 53240-2:2007-11 of not more than 20 mg KOH/g,
(c) at least one compound (c) having at least one isocyanate-reactive group and at least one free-radically polymerizable unsaturated group,
(d) at least one compound having at least one isocyanate-reactive group and at least one acid group,
(e) at least one base of an alkali metal for at least partial neutralization of the acid groups of component (d),
(f) optionally at least one monoalcohol having exactly one hydroxyl function, or at least one mono- and di-C₁-C₄-alkylamine,
(g) at least one monofunctional polyalkylene oxide polyether alcohol.

According to a twentieth embodiment, the present invention relates to a method as claimed in embodiment 19, wherein component (a) is a mixture of a cycloaliphatic or aliphatic monomeric diisocyanate (a1) and a polyisocyanate (a2) based on a cycloaliphatic or aliphatic monomeric diisocyanate.

According to a twenty-first embodiment, the present invention relates to a method as claimed in embodiment 20, wherein component (a1) is selected from the group consisting of hexamethylene diisocyanate, 1,3-bis(isocyanatomethyl)cyclohexane, isophorone diisocyanate, 4,4′- or 2,4′-di(isocyanatocyclohexyl)methane and mixtures thereof, preferably from isophorone diisocyanate and hexamethylene diisocyanate, very preferably from hexamethylene diisocyanate.

According to an twenty-second embodiment, the present invention relates to a method as claimed in embodiments 20 or 21, wherein polyisocyanate (a2) is a polyisocyanate having isocyanurate groups, a uretdione diisocyanate, a polyisocyanate having biuret groups, a polyisocyanate having urethane or allophanate groups and mixtures thereof.

According to a twenty-third embodiment, the present invention relates to a method as claimed in any of embodiments 20 to 22, wherein polyisocyanate (a2) is a compound of the formula (I)

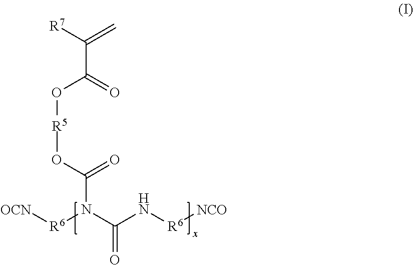

in which
R⁵ is a divalent alkylene radical which has 2 to 12 carbon atoms, preferably having 2 to 10 carbon atoms, more preferably 2 to 8 and most preferably having 3 to 6 carbon atoms, very preferably 1,2-ethylene,
R⁶ is a divalent alkylene radical or cycloalkylene radical which has 2 to 20 carbon atoms, preferably having 4 to 15 carbon atoms, more preferably having 6 to 13 carbon atoms, very preferably 1,6-hexylene,
R⁷ is hydrogen or methyl, preferably hydrogen, and
X is a positive number having a statistical average of 2 up to 6, preferably of 2 to 4.

According to a twenty-fourth embodiment, the present invention relates to a method as claimed in any of embodiments 19 to 23, wherein component (b1) is selected from the group consisting of ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, heptane-1,7-diol, octane-1,8-diol, octane-1,2-diol, nonane-1,9-diol, decane-1,2-diol, decane-1,10-diol, dodecane-1,2-diol, dodecane-1,12-diol, 1,5-hexadiene-3,4-diol, neopentyl glycol, 2-butyl-2-ethylpropane-1,3-diol, 2-methylpentane-2,4-diol, 2,4-dimethylpentane-2,4-diol, 2-ethylhexane-1,3-diol, 2,5-dimethylhexane-2,5-diol, 2,2,4-trimethylpentane-1,3-diol, pinacol, diethylene glycol, triethylene glycol, dipropylene glycol, tripropylene glycol and mixtures thereof.

According to a twenty-fifth embodiment, the present invention relates to a method as claimed in any of embodiments 19 to 24, wherein component (b2) is a polyester diol having a weight-average molar mass M_{w} of 700 to 2000 g/mol and an acid number according to DIN 53240-2:2007-11 of not more than 20 mg KOH/g.

According to a twenty-sixth embodiment, the present invention relates to a method as claimed in any of embodiments 19 to 25, wherein component (c) is selected from the group consisting of 2-hydroxyethyl acrylate, 2-hydroxyethyl methacrylate, 2- or 3-hydroxypropyl acrylate and butane-1,4-diol monoacrylate, 1,2- or 1,3-diacrylate of glycerol, trimethylolpropane diacrylate, pentaerythrityl triacrylate, ditrimethylolpropane triacrylate, dipentaerythrityl pentaacrylate and mixtures thereof, preferably 2-hydroxyethyl acrylate.

According to a twenty-seventh embodiment, the present invention relates to a method as claimed in embodiments 19 to 26, wherein component (d) is dimethylolpropionic acid.

According to a twenty-eighth embodiment, the present invention relates to a method as claimed in embodiments 19 to 27, wherein component (f) is selected from the group consisting of diethylamine, di-n-butylamine, ethanolamine, propanolamine, N,N-dipropanolamine, N,N-diethanolamine and mixtures thereof.

According to an twenty-ninth embodiment, the present invention relates to a method as claimed in any of the preceding embodiments, wherein the polyurethane (meth)acrylate polymer has a weight average molecular weight M_{w} of 1,000 to 50,000, more particularly of 3,000 to 30,000, very preferably 5,000 to 25,000 g/mol, determined by gel permeation chromatography with tetrahydrofuran and polystyrene as standard.

According to a thirtieth embodiment, the present invention relates to a method as claimed in any of the preceding embodiments, wherein the polyurethane (meth)acrylate polymer contains 1 to 5 mol, preferably 2 to 4 mol, of (meth)acryloyl groups per 1,000 g of polyurethane (meth)acrylate.

According to a thirty-first embodiment, the present invention relates to a method as claimed in any of the preceding embodiments, wherein the ink composition (AC) comprises the at least one aqueous dispersion of a polyurethane (meth)acrylate polymer (i) in a total amount of 15 to 95 parts, preferably 20 to 50 parts, very preferably 25 to 35 parts, based on 100 parts of the ink composition.

According to a thirty-second embodiment, the present invention relates to a method as claimed in any of the preceding embodiments, wherein the at least one pigment (ii) is selected from the group consisting of inorganic pigments, such as titanium dioxide, zinc white, zinc sulfide, lithopone, carbon black, iron manganese black, spinel black, chromium oxide, chromium oxide hydrate green, cobalt green, ultramarine green, cobalt blue, ultramarine blue, manganese blue, ultramarine violet, cobalt violet and manganese violet, red iron oxide, cadmium sulfoselenide, molybdate red, and ultramarine red, brown iron oxide, mixed brown, spinel phases and corundum phases, and chromium orange, yellow iron oxide, nickel titanium yellow, chromium titanium yellow, cadmium sulfide, cadmium zinc sulfide, chromium yellow, and bismuth vanadate; organic pigments, such as monoazo pigments, disazo pigments, anthraquinone pigments, benzimidazole pigments, quinacridone pigments, quinopthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments and/or aniline black; and mixtures thereof.

According to a thirty-third embodiment, the present invention relates to a method as claimed in any of the preceding embodiments, wherein the ink composition (AC) comprises the at least one pigment and/or dye (ii) in a total amount of 0.01 to 5 parts, preferably 0.1 to 2.5 parts, very preferably 0.2 to 0.5 parts, based on 100 parts of the ink composition.

According to a thirty-fourth embodiment, the present invention relates to a method as claimed in any of the preceding embodiments, wherein the at least one photoinitiator (iii) is selected from the group consisting of phosphine oxides, benzophenones, thioxanthones, anthraquinones, acetophenones such as α-aminoaryl ketones and/or α-hydroxyalkyl aryl ketones, benzoins and benzoin ethers, ketals, imidazoles or phenylglyoxylic acids, and mixtures thereof.

According to a thirty-fifth embodiment, the present invention relates to a method as claimed in any of the preceding embodiments, wherein the at least one photoinitiator (iii) is selected from a mixture of bis-acetylphospine oxide and monoacylphosphine oxide.

According to a thirty-sixth embodiment, the present invention relates to a method as claimed in any of the preceding embodiments, wherein the ink composition (AC) comprises the at least one photoinitiator (iii) in a total amount of 0.01 to 8 parts, preferably 0.1 to 7 parts, more preferably 0.2 to 5 parts, very preferably 0.2 to 1.5 parts, based on 100 parts of the ink composition.

According to a thirty-seventh embodiment, the present invention relates to a method as claimed in any of the preceding embodiments, wherein the ink composition (AC) further comprises at least one surfactant (iv).

According to a thirty-eighth embodiment, the present invention relates to a method as claimed in embodiment 37, wherein the at least one surfactant (iv) is selected from the group consisting of nonionic surfactants, anionic surfactants, cationic surfactants, fluorinated surfactants, silicone surfactants and mixtures thereof, preferably non-ionic acetylenic surfactants and/or silicon surfactants.

According to a thirty-ninth embodiment, the present invention relates to a method as claimed in embodiment 38, wherein the nonionic surfactant is selected form the group consisting of acetylenic surfactants such as 3,6-dimethyl-4-octyne-3,6-diol, 2,4,7,9-tetramethyl-5-decin-4,7-diol and ethoxylated acetylenic surfactants; reaction products of poly(oxyalkylene glycol) with C₈-C₃₀ carboxylic acids, C₈-C₃₀ alcohols, C₈-C₃₀ amines, sorbitan esters, alkanol amides, castor oil; C₈-C₃₀ amines and derivates thereof; nonionic polymers such as poly(propylene oxide)/poly(ethylene oxide) copolymers, poly(alkylene glycol), polyvinyl alcohol, polyacrylic acid, hydrophobically-substituted polyacryl amide, methyl cellulose, ethyl cellulose, hydroxy ethyl cellulose, carboxy methyl cellulose, polyoxyethylene alkyl ethers, polyoxyethylene nonylphenyl ether, alkyl or dialkyl phenoxy poly(ethyleneoxy)ethanol derivatives defoaming silicon compounds, blends of organic esters in mineral oil base, EO/PO block copolymers; and mixtures thereof, preferably 2,4,7,9-tetramethyl-5-decin-4,7-diol.

According to a fortieth embodiment, the present invention relates to a method as claimed in embodiments 38 or 39, wherein the anionic surfactant is selected form the group consisting of sulphonated fatty esters, phosphated fatty esters, alkyl sulphoxides and alkyl sulphones, sodium alkyl sulphates, sodium dodecylbenzene sulphonate, sodium dodecyl naphthalene sulphate, sodium dodecyl diphenyloxide disulphonate, sodium alkyl sulphosuccinates, potassium N-methyl-N-oleoyl taurate, carboxymethylamylose and mixtures thereof.

According to forty-first embodiment, the present invention relates to a method as claimed in any of embodiments 38 to 40, wherein the cationic surfactant is selected form the group consisting of dialkyl benzenealkyl ammonium chloride, alkylbenzyl methyl ammonium chloride, cetyl pyridinium bromide, alkyl trimethyl ammonium bromides, halide salts of quaternized polyoxyethylalkylamines, dodecylbenzyl triethyl ammonium chloride, quaternary alkosulphate compounds, fatty imidazolines and mixtures thereof.

According to forty-second embodiment, the present invention relates to a method as claimed in any embodiments 37 to 41, wherein the ink composition (AC) comprises at least one surfactant (iv) containing at least one non-ionic acetylenediol-based surfactant (iv-1), preferably 2,4,7,9-tetramethyl-5-decin-4,7-diol, and/or at least one silicon surfactant (vi-2), preferably a polyether modified siloxane.

According to forty-third embodiment, the present invention relates to a method as claimed in any of embodiments 37 to 42, wherein the ink composition (AC) comprises the at least one surfactant (iv), preferably the at least one nonionic surfactant and/or the at least one silicon surfactant, very preferably 2,4,7,9-tetramethyl-5-decin-4,7-diol and/or polyether modified siloxane, in a total amount of 0.01 to 1 parts, preferably 0.02 to 0.5 parts, very preferably 0.02 to 0.2 parts, based on 100 parts of the aqueous ink composition (AC).

According to a forty-fourth embodiment, the present invention relates to a method as claimed in any of the preceding embodiments, wherein the ink composition (AC) further comprises at least one additive (v), selected from the group consisting of rheology modifiers (v-1), humectants (v-2), co-solvents (v-3), biocides (v-4) and mixtures thereof.

According to a forty-fifth embodiment, the present invention relates to a method as claimed in embodiment 44, wherein the ink composition (AC) comprises the at least one rheology modifier (v-1) in a total amount of 0.01 to 1 parts, based on 100 parts of the ink composition.

According to a forty-sixth embodiment, the present invention relates to a method as claimed in embodiments 44 or 45, wherein the ink composition (AC) comprises the at least one humectant (v-2) in a total amount of 0.01 to 30 parts, based on 100 parts of the ink composition.

According to a forty-seventh embodiment, the present invention relates to a method as claimed in any of embodiments 44 to 46, wherein the ink composition (AC) comprises the at least one co-solvent (v-3) in a total amount of 0.01 to 30 parts, based on 100 parts of the ink composition.

According to a forty-eighth embodiment, the present invention relates to a method as claimed in any of embodiments 44 to 47, wherein the ink composition (AC) comprises the at least one biocide (v-4) in a total amount of 0.01 to 1 parts, based on 100 parts of the ink composition.

According to a forty-ninth embodiment, the present invention relates to a method as claimed in any of the preceding embodiments, wherein the ink composition (AC) comprises (meth)acrylates with a number average molecular weight Mₙ of less than 1,200 g/mol in a total amount of 0 to 2% by weight, preferably 0 to 1% by weight, very preferably 0% by weight, based on the total weight of the ink composition (AC).

According to a fiftieth embodiment, the present invention relates to a method as claimed in any of the preceding embodiments, wherein the ink composition (AC) is an aqueous ink composition and comprises water in a total amount of 5 to 95 parts, preferably 35 to 95 parts, more preferably 50 to 90 parts, very preferably 60 to 90 parts, based on 100 parts of the aqueous ink composition (AC).

According to a fifty-first embodiment, the present invention relates to a method as claimed in any of the preceding embodiments, wherein the ink composition (AC), preferably the aqueous ink composition (AC), has a solids content of 8 to 40 parts, preferably 20 to 40 parts, very preferably 25 to 35 parts, based on 100 parts of the ink composition.

According to a fifty-second embodiment, the present invention relates to a method as claimed in any of the preceding embodiments, wherein the ink composition (AC), preferably the aqueous ink composition (AC), has a viscosity of 0.01 to 100 mPa*s, preferably of 5 to 30 mPa*s, more preferably 4 to 20 mPa*s, very preferably of 2 to 15 mPa*s, determined using a rotational viscosimeter at 23° C. and a shear rate of 1000 s⁻¹.

According to a fifty-third embodiment, the present invention relates to a method as claimed in any of the preceding embodiments, wherein the ink composition (AC), preferably the aqueous ink composition, has a surface tension of 10 to 70 mN/m, more preferably of 15 to 60 mN/m, very preferably of 20 to 50 mN/m, measured according to DIN EN 14210:2004-03 (ring method) at 23° C.

According to a fifty-fourth embodiment, the present invention relates to a method as claimed in any of the preceding embodiments, wherein the ink composition (AC) in step (3) is deposited by means of a digital printing device comprising a Drop-on-Demand (DOD) inkjet printer.

According to a fifty-fifth embodiment, the present invention relates to a method as claimed in embodiment 54, wherein the Drop-on-Demand (DOD) inkjet printer has at least one printhead, wherein the at least one printhead has one or more nozzles whose diameter is in each case in the range from 1 to 52 μm, more preferably from 15 to 40 μm, very preferably from 30 to 40 μm.

According to a fifty-sixth embodiment, the present invention relates to a method as claimed in embodiment 55, wherein the printhead has 1 to 1024, preferably 50 to 500, very preferably 110 to 140 nozzles.

According to a fifty-seventh embodiment, the present invention relates to a method as claimed in embodiments 55 or 56, wherein the printhead discharges the aqueous ink composition in a drop size of 1 to 200 pl, preferably 15 to 100 pl, very preferably 25 to 35 pl.

According to a fifty-eighth embodiment, the present invention relates to a method as claimed in any of embodiments 55 to 57, wherein the angle of the printhead is in the range from 0° to 90°, more preferably 0 to 45°, very preferably 0°.

According to a fifty-ninth embodiment, the present invention relates to a method as claimed in any of embodiments 55 to 58, wherein a distance between the part to be printed of the at least one surface of the non-woven textile substrate (S) and the at least one nozzle of the at least one printhead in step (3) is 0.1 mm to 4 cm, preferably 0.5 to 1.5 mm.

According to a sixtieth embodiment, the present invention relates to a method as claimed in any of the preceding embodiments, wherein the printing speed is 50 to 500 mm/s, preferably 100 to 300 mm/s, very preferably 150 to 250 mm/s.

According to a sixty-first embodiment, the present invention relates to a method as claimed in any of the preceding embodiments, wherein the printing in step (3) is performed at a jetting temperature of 15 to 50° C., preferably 20 to 30° C., very preferably 23° C.

According to a sixty-second embodiment, the present invention relates to a method as claimed in any of the preceding embodiments, wherein the drying of the ink composition (AC), preferably the aqueous ink composition (AC), in step (4) is performed at 30 to 100° C., preferably 50 to 70° C., for a duration of 1 to 60 minutes, preferably 5 to 30 minutes, very preferably 5 to 20 minutes.

According to a sixty-third embodiment, the present invention relates to a method as claimed in any of the preceding embodiments, wherein the curing of the ink composition (AC) in step (4) is performed under nitrogen atmosphere.

According to a sixty-fourth embodiment, the present invention relates to a method as claimed in any of the preceding embodiments, wherein the curing of the ink composition (AC) in step (4) is performed by means of radiation curing, preferably by means of UV light and/or electron beam curing (EBC), very preferably by means of UV light.

According to a sixty-fifth embodiment, the present invention relates to a method as claimed in any of the preceding embodiments, wherein the curing of the ink composition (AC) in step (4) is performed by means of UV light using an intensity of 1 to 10 W/cm², preferably 1 to 6 W/cm² and/or a dose of 1 to 20 J/cm², more preferably 1 to 12 J/cm².

According to a sixty-sixth embodiment, the present invention relates to a method as claimed in any of embodiments 1 to 64, wherein the curing of the ink composition (AC) in step (4) is performed by means of electron beam curing using an intensity of 30 to 80 kGy, preferably 40 to 60 kGy, very preferably 50 kGy.

According to a sixty-seventh embodiment, the present invention relates a non-woven textile substrate (S) at least partially coated with an ink layer (IL), said substrate being produced by the method as claimed in any of embodiments 1 to 64.

### EXAMPLES

The present invention will now be explained in greater detail using working examples, but the present invention is in no way limited to these working examples. Moreover, the terms “parts”, “%” and “ratio” in the examples denote “parts by mass”, “mass %” and “mass ratio” respectively unless otherwise indicated.

### Methods of Determination

### 1. Solids Content (Solids, Nonvolatile Fraction)

Unless otherwise indicated, the solids content, also referred to as solid fraction hereinafter, was determined in accordance with DIN EN ISO 3251:2018-07 at 120° C. and 60 min, initial mass 1.0 g.

### 2. Viscosity

The viscosity is determined with a rotational viscosimeter (rheometer MCR302, measuring geometry DG42) at 23° C. using a shear rate of 1000 s⁻¹.

### 3. Surface Tension

The surface tension was measured by using a Krüss tensiometer K100 with ptlr ring according to DIN EN 14210:2004-03 (ring method) at 23° C.

### Inventive Examples

The inventive examples below serve to elucidate the invention, but should not be interpreted as imposing any limitation.

Unless otherwise indicated, the figures in parts are parts by weight, and figures in percent are in each case percentages by weight.

### 1. Production of Aqueous Ink Compositions AC

The aqueous ink compositions AC-1 to AC-6 were produced in accordance with table 1 below by mixing the components stated therein.

TABLE 1
radiation curable ink compositions AC (amounts in wt %)

| Component | AC-1 | AC-2 | AC-3 | AC-4 | AC-5 | AC-6 |
|---|---|---|---|---|---|---|
| aqueous dispersion of a | 33.97 | 30.68 | 27.97 | 34.01 | 30.72 | 28.01 |
| urethane (meth)acrylate | | | | | | |
| polymer ¹⁾ | | | | | | |
| Pigment ²⁾ | 0.81 | 0.73 | 0.67 | 0.81 | 0.73 | 0.67 |
| Photoinitiator ³⁾ | 0.81 | 0.73 | 0.67 | 0.81 | 0.73 | 0.67 |
| Surfactant (iv-1) ⁴⁾ | 0.08 | 0.07 | 0.07 | 0.08 | 0.07 | 0.07 |
| Surfactant (iv-2) ⁵⁾ | 0.10 | 0.10 | 0.10 | — | — | — |
| Water | 64.24 | 67.69 | 70.53 | 64.29 | 67.74 | 70.59 |
| Solid content | 14.1 | 12.9 | 11.8 | 14.09 | 12.91 | 11.8 |
| Viscosity (1000 s⁻¹) | 3.0 | 2.6 | 2.4 | 3.5 | 2.8 | 2.7 |
| Surface tension (23° C.) | 30.2 | 29.8 | 29.8 | 41.2 | 41.2 | 41.4 |

¹⁾ Laromer ® UA 9122 Aqua (BASF SE; solids content 37 to 39 wt %)
²⁾ Dispers blue 70-0507 (BASF SE; 40% by weight pigment)
³⁾ Omnirad 2100 (IGM Resins; phosphine oxide)
⁴⁾ TMDD BG 52 (BASF SE; 2,4,7,9-tetramethyl-5-decin-4,7-diol)
⁵⁾ BYK 346 (BYK; polyether modified siloxane of general formula (I))

### 2. Substrates

Substrate S1 was prepared from Elastollan® 1180 A 10 and has a base weight of 400 g/m²

Substrate S2 was prepared from Elastollan® B 85 A 10 and has a base weight of 500 g/m²

Elastollan® 1180 A 10: thermoplastic polyurethane based on (a) 4,4′-diphenylmethane diisocyanate (MDI), (b) polytetrahydrofuran (Poly-THF) and (c) 1,4-butanediol having the following properties:
a Shore hardness of 80 A (DIN ISO 7619-1:2012-02,measuring time=3 s),
a glass transition temperature of −44° C. (11357-1:2017-02, heating rate=10° C./min),
a vicat softening temperature of 90° C. (DIN EN ISO 306:2014-03, heating rate=120° C./h, load=10N),
a tensile strength of 45 MPa (DIN 53504:2009-10, tension bar S2),
an elongation at break of 650% (DIN 53504:2009-10, tension bar S2),
a tear strength of 55 kN/m (DIN EN ISO 34-1:2004-07, method B, procedure (a)) and
an abrasion loss of 30 mm³ (DIN EN ISO 4649:2010-09, Method A).

Elastollan® B 85 A 10: thermoplastic polyurethane based on (a) 4,4′-diphenylmethane diisocyanate and/or hexamethylene 1,6-diisocyanate, (b) 1,4-butanediol and/or 1,6-hexanediol polyadipates and (c) 1,2-ethanediol, 1,4-butanediol and/or 1,6-hexanediol having the following properties:
a Shore hardness of 83 A (DIN ISO 7619-1:2012-02,measuring time=3 s),
a glass transition temperature of −44° C. (DIN EN ISO 11357-1:2017-02, heating rate=10° C./min),
a vicat softening temperature of 100 to 120° C. (DIN EN ISO 306:2014-03, heating rate=120° C./h, load=10N),
a tensile strength of 55 MPa (DIN 53504:2009-10, tension bar S2),
an elongation at break of 600% (DIN 53504:2009-10, tension bar S2),
a tear strength of 75 kN/m (DIN EN ISO 34-1:2004-07, method B, procedure (a)) and
an abrasion loss of 35 mm³ (DIN EN ISO 4649:2010-09, Method A).

### 3. Printing Process

The ink compositions AC-1 to AC-6 are each printed onto the substrates S1 and S2, respectively, using a commercially available printer from Mayer Burger Technology AG, Switzerland. The printer used is the Pixdro LP50 model, which has piezoelectric printheads each having a diameter of 35 μm (Spectra SE 128 AA from Fujifilm). The resolution was 800 to 1,600 dpi.

### 4. Drying Process

After printing of the ink compositions AC-1 to AC-6 onto substrates S1 and S2, the printed substrates are dried at 60° C. for 10 minutes.

### 5. Curing Process

Curing of all printed substrates to provide a cured ink layer (IL) on the respective substrate is done by radiation curing using an IST curing belt and the following parameters:
UV lamp: 2×mercury lamp (power 200 W/cm)
Intensity: approx. 1 W/cm²
Dose: approx. 6 to 8 J/cm²
Atmosphere: nitrogen (<0.1% A oxygen) or ambient atmosphere

### 6. Results

All substrates were successfully printed in high resolution without negatively influencing the properties or the haptic of substrates comprising the cured ink layer.

Using only surfactant (iv-1) leads to decreased color boundary bleeding as compared to ink compositions, comprising surfactants (iv-1) and (iv-2).

Curing of the printed inks could be enhanced by using a nitrogen atmosphere instead of an ambient atmosphere.

1. An aqueous coating composition, comprising:
(a) at least one aqueous dispersion of core/shell type particles comprising a polyurethane resin as the core portion and a crosslinked acrylic resin as the shell portion, wherein the particles are obtained by:
(i) initially charging an aqueous dispersion of at least one polyurethane resin (P) as core portion, and then
(ii) polymerizing a mixture of olefinically unsaturated monomers in the presence of the polyurethane core portion to obtain the crosslinked acrylic resin (A) shell portion,
wherein:
(ii-1) the polymerizing occurs in the presence of a water-soluble initiator;
(ii-2) a metered addition of the olefinically unsaturated monomers occurs such that a concentration of 6% by weight, based on a total amount of the olefinically unsaturated monomers, in a reaction solution of the polymerizing is not exceeded during the entire duration of the polymerizing; and
(ii-3) the mixture of the olefinically unsaturated monomers comprises at least one polyolefinically unsaturated monomer, and
(b) at least one aqueous polyurethane-polyurea dispersion comprising polyurethane-polyurea particles having an average particle size of 40 to 2,000 nm and a gel fraction of at least 50%, the polyurethane-polyurea particles contain, in each case in reacted form:
at least one polyurethane prepolymer (PP) comprising isocyanate groups and comprising anionic groups and/or groups which are configured to be converted into anionic groups, and
at least one polyamine (PA) comprising two primary amino groups and one or two secondary amino groups.

2. The aqueous coating composition as claimed in claim 1, wherein the glass transition temperature T_{g} of the polyurethane resin (P) of the core portion is from −80° C. to 105° C., and/or wherein the glass transition temperature T_{g} of the crosslinked acrylic resin (A) of the shell portion is from −60° C. to 80° C.

3. The aqueous coating composition as claimed in claim 1, wherein the polyurethane resin (P) of the core portion has an acid number of 10 to 60 mg KOH/g, and a OH number of 20 to 80 mg KOH/g

4. The aqueous coating composition as claimed in claim 1, wherein the crosslinked acrylic resin (A) of the shell portion has an OH number of 10 to 140 mg KOH/g, and an acid number of 0 to 10 mg KOH/g.

5. The aqueous coating composition as claimed in claim 1, wherein the aqueous dispersion (a) has a gel content of 40 to 97% by weight, based on solids in the dispersion.

6. The method as claimed in claim 1, wherein the aqueous coating composition comprises the at least one aqueous dispersion (a) in a total amount of 0.5 to 50% by weight, based on the total amount of the aqueous coating composition.

7. The aqueous coating composition as claimed in claim 1, wherein the aqueous dispersion (b) has a gel fraction of 70% to 100%, based on the solids of the dispersion (b).

8. The aqueous coating composition as claimed in claim 1, wherein the polyurethane prepolymer (PP) comprises at least one polyester diol which is a product of a diol and a dicarboxylic acid, and wherein at least 50% by weight of the dicarboxylic acid in preparation of the at least one polyester diol is at least one dimer fatty acid.

9. The aqueous coating composition as claimed in claim 1, wherein the polyurethane prepolymer (PP) has an acid number, based on the solids content, of 10 to 35 mg KOH/g.

10. The aqueous coating composition as claimed in claim 1, wherein the polyurethane prepolymer (PP) has an isocyanate content of 0.5 to 6% by weight.

11. The aqueous coating composition as claimed in claim 1, wherein the at least one polyamine (PA) is at least one selected from the group consisting of diethylenetriamine, 3-(2-aminoethyl)-aminopropylamine, dipropylenetriamine, N1-(2-(4-(2-aminoethyl)piperazin-1-yl)ethyl)ethane-1,2-diamine, triethylenetetra-mine, and N,N′-bis(3-amino-propyl)ethylenediamine and mixtures thereof.

12. The aqueous coating composition as claimed in claim 1, wherein the aqueous coating composition comprises the at least one aqueous dispersion (b) in a total amount of 10 to 55% by weight, based on the total amount of the aqueous coating composition.

13. The aqueous coating composition as claimed in claim 1, wherein the composition comprises a weight ratio of the at least one aqueous dispersion of core/shell type particles (a) to the at least one aqueous polyurethane-polyurea dispersion (b) of 2:1 to 1:15, based on the solid content of the dispersions.

14. A method for forming a multilayer coating (MC) on a substrate (S) comprising the following steps:
(1) coating a first aqueous coating material (X) directly on the substrate (S) to form an uncured first coating film (x),
(2) coating a second aqueous coating material (Y) directly on the uncured first coating film obtained after step (1) to form an uncured second coating film (y),
(3) coating a clear coating material (Z) directly on the uncured second coating film obtained after step (2) to form a clear coating film (z), and
(4) simultaneously curing these three coating films obtained after steps (1) to (3),
characterized in that
the first aqueous coating material (X) and/or the second aqueous coating material (Y) are selected from the group consisting of an aqueous coating composition as claimed in claim 1.

15. A multilayer coating (MC) produced by the method as claimed in claim 14.

16. The aqueous coating composition as claimed in claim 1, wherein the aqueous coating composition is a pigmented aqueous basecoat composition.

17. The aqueous coating composition as claimed in claim 1, wherein the glass transition temperature T_{g} of the polyurethane resin (P) of the core portion is from −60° C. to 80° C., and/or wherein the glass transition temperature T_{g} of the crosslinked acrylic resin (A) of the shell portion is from −60° C. to 20° C.

18. The aqueous coating composition as claimed in claim 1, wherein the polyurethane resin (P) of the core portion has an acid number of 30 to 40 mg KOH/g.

19. The aqueous coating composition as claimed in claim 1, wherein the aqueous dispersion (a) has a gel content of 75 to 90% by weight, based on solids in the dispersion.

20. The aqueous coating composition as claimed in claim 1, wherein the aqueous coating composition comprises the at least one aqueous dispersion (a) in a total amount of 2 to 40% by weight, based on the total amount of the aqueous coating composition.
